(19) United States
(12) Patent Application Publication
(10) Pub. No.: US 2025/0274245 A1
(43) Pub. Date: Aug. 28, 2025

(54) PDCP-RLC SEQUENCE NUMBER BINDING

(71) Applicant: QUALCOMM Incorporated, San Diego, CA (US)

(72) Inventors: Sherif ELAZZOUNI, San Diego, CA (US); Ozcan OZTURK, San Diego, CA (US); Vishal DALMIYA, San Diego, CA (US); Lulu WANG, San Diego, CA (US)

(21) Appl. No.: 18/589,325

(22) Filed: Feb. 27, 2024

(51) Int. Cl. H04L 5/00; H04L 47/34; H04W 72/1263

(52) U.S. Cl. CPC H04L 5/0055; H04L 5/0035; H04L 47/34; H04W 72/1263

(57) ABSTRACT

A method for wireless communication at a user equipment (UE) and related apparatus are provided. In the method, the UE receives a configuration from a network entity. The configuration includes a mapping relationship binding a first set of packet data convergence protocol (PDCP) sequence numbers (SNs) respectively to a second set of radio link control (RLC) SNs. The UE further communicates a data packet with the network entity based on the mapping relationship.

### TECHNICAL FIELD

The present disclosure relates generally to communication systems and, more particularly, to the binding of packet data convergence protocol (PDCP) and radio link control (RLC) sequence numbers in wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor, individually or in any combination, may be configured to receive, from a network entity, a configuration including a mapping relationship binding a first set of packet data convergence protocol (PDCP) sequence numbers (SNs) respectively to a second set of radio link control (RLC) SNs; and communicate, based on the mapping relationship, a data packet with the network entity.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor, individually or in any combination, may be configured to transmit, for a UE, a configuration including a mapping relationship binding a first set of PDCP SNs respectively to a second set of RLC SNs; and communicate, based on the mapping relationship, a data packet with the UE.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 illustrates an example of extended reality (XR) traffic flows.

FIG. 5 is a diagram illustrating an example of the gap in the packet data convergence protocol (PDCP) sequence numbers (SNs).

FIG. 6 is a diagram illustrating an example of the gap in the PDCP SNs.

FIG. 7 is a diagram illustrating an example of the gap in the PDCP SNs.

FIG. 8 is a diagram illustrating an example of a radio link control (RLC) header indicating the PDCP and RLC SNs binding relationship in accordance with various aspects of the present disclosure.

FIG. 9 is a diagram illustrating an example RLC header indicating the gaps between PDCP SNs of consecutive PDCP transmissions in DC communication.

FIG. 10 is a diagram illustrating example values of the gaps between PDCP SNs of consecutive PDCP transmissions in dual connectivity (DC) communication.

FIG. 11 is a call flow diagram illustrating a method of wireless communication in accordance with various aspects of the present disclosure.

FIG. 12 is a flowchart illustrating methods of wireless communication at a UE in accordance with various aspects of the present disclosure.

FIG. 13 is a flowchart illustrating methods of wireless communication at a UE in accordance with various aspects of the present disclosure.

FIG. 14 is a flowchart illustrating methods of wireless communication at a network entity in accordance with various aspects of the present disclosure.

FIG. 15 is a flowchart illustrating methods of wireless communication at a network entity in accordance with various aspects of the present disclosure.

FIG. 16 is a diagram illustrating an example of a hardware implementation for an example apparatus and/or network entity.

FIG. 17 is a diagram illustrating an example of a hardware implementation for an example network entity.

### DETAILED DESCRIPTION

In wireless communication, the packet data convergence protocol (PDCP) layer and the radio link control (RLC) layer may coordinate for data packet transmission, and both layers may use sequence numbers (SN) to facilitate the transmission of data packets. For example, each data packet prepared for transmission in the PDCP layer may be assigned a SN (a PDCP SN). These PDCP SNs may be used to, for example, ensure the proper order of the data packets and identify any packets that may be missing. However, during the data transmission, gaps in PDCP SNs may occur on the receiver (e.g., a user equipment (UE)) as a result of, for example, data loss or delay or the variations in transmission rate (e.g., in scenarios involving dual connectivity (DC)) of the data packets over the F1 interface. Due to a lack of the information on the causes of the gaps in the PDCP SNs on the receiver, these gaps may cause unnecessary RLC retransmission. Such retransmission may significantly impact the latency of wireless communication and is particularly detrimental for latency-sensitive applications, such as extended reality (XR) applications. Example aspects presented herein provide methods and apparatus to inform the receiver of the SN gaps or missing SNs in the PDCP layer to minimize unnecessary RLC retransmission.

Various aspects relate generally to wireless communication. Some aspects more specifically relate to the binding of PDCP and RLC SNs in wireless communication. In some examples, a UE receives a configuration from a network entity. The configuration includes a mapping relationship binding a first set of PDCP SNs respectively to a second set of RLC SNs. The UE further communicates a data packet with the network entity based on the mapping relationship. In some examples, the UE may identify, based on the mapping relationship and one of the first set of PDCP SNs and the second set of RLC SNs, a transmission status associated with the other one of the first set of PDCP SNs and the second set of RLC SN; and communicate the data packet with the network entity based on the transmission status.

Particular aspects of the subject matter described in this disclosure can be implemented to realize one or more of the following potential advantages. In some examples, through a binding relationship between PDCP SNs and RLC SNs, the described techniques may be used to ensure a more efficient handling of packet losses (e.g., packet loss on F1 interface) and reduce unnecessary RLC retransmission, especially in scenarios involving dual connectivity (DC) and varying network conditions, thereby improving the reliability and efficiency of wireless communication. In some examples, by allowing a dynamic adjustment of the binding between PDCP and RLC SNs based on the transmission conditions, the described techniques may be used to ensure the binding can be optimized in real-time for the current network environment, thereby improving packet delivery and handling efficiency. For example, aspects presented herein enable a receiver to obtain information indicating an SN gap (or missing SNs) for PDSCH reordering. The information helps the receiver to avoid waiting for a SN that will not be received. In some examples, by enabling the UE to map the PDCP reordering window to RLC SNs and vice versa, the described techniques may be used to improve the handling of packet loss and reordering.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

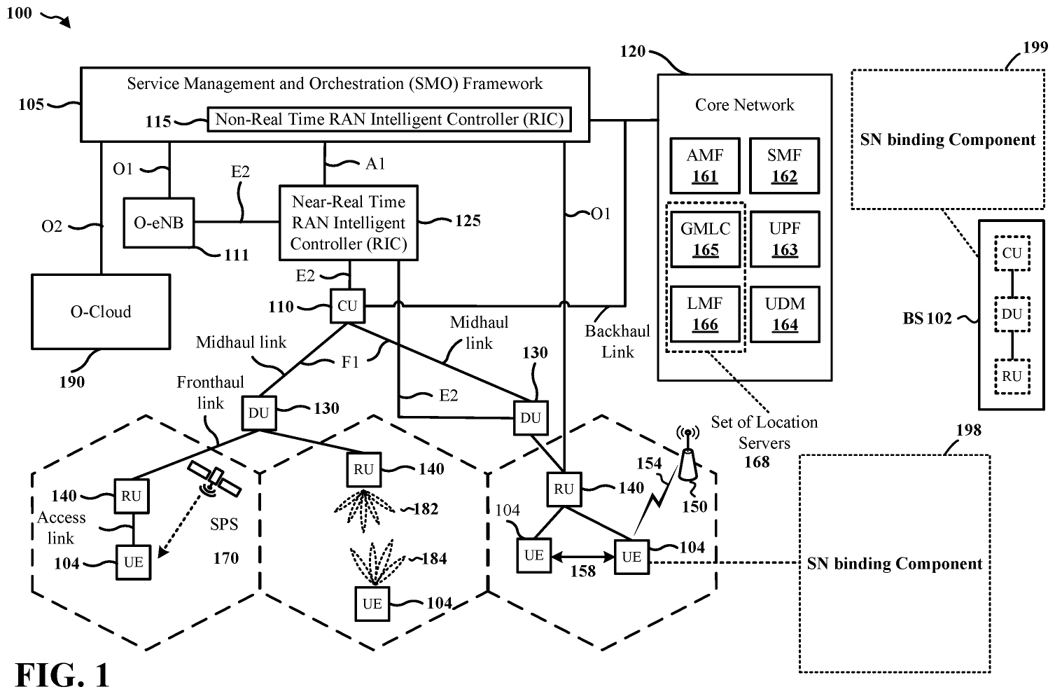

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an El interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell). Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include an SN binding component 198. The SN binding component 198 may be configured to receive, from a network entity, a configuration including a mapping relationship binding a first set of PDCP SNs respectively to a second set of RLC SNs; and communicate, based on the mapping relationship, a data packet with the network entity. In certain aspects, the base station 102 may include an SN binding component 199. The SN binding component 199 may be configured to transmit, for a UE, a configuration including a mapping relationship binding a first set of PDCP SNs respectively to a second set of RLC SNs; and communicate, based on the mapping relationship, a data packet with the UE. Although the following description may be focused on 5G NR, the concepts described herein may be applicable to other similar areas, such as LTE, LTE-A, CDMA, GSM, and other wireless technologies.

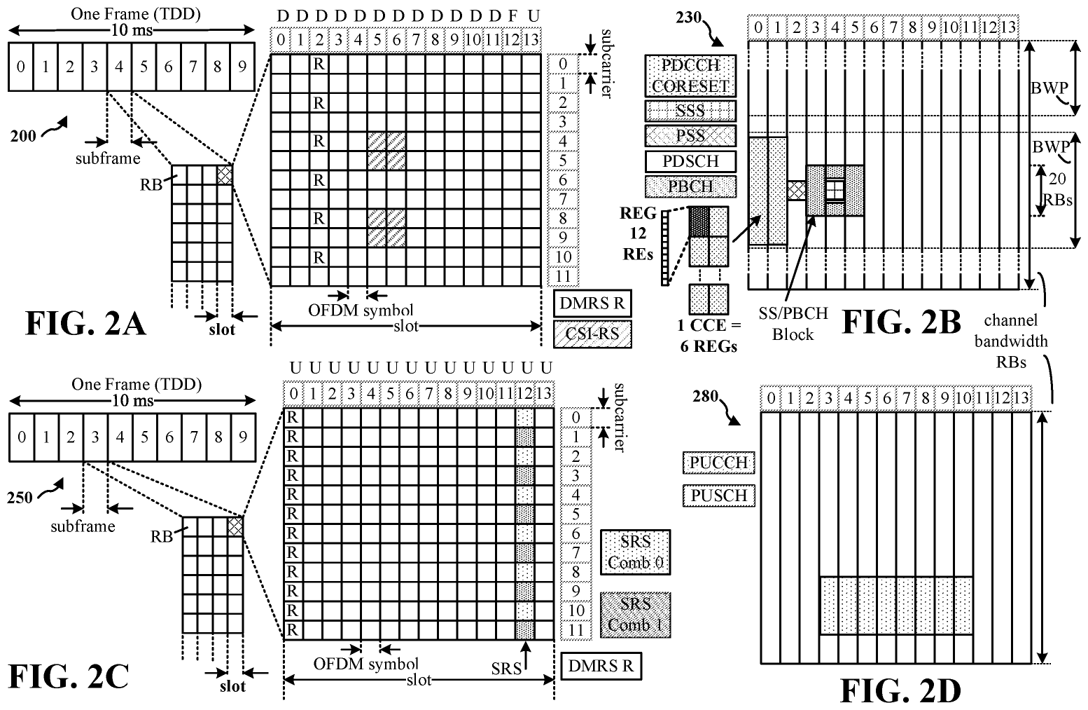

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

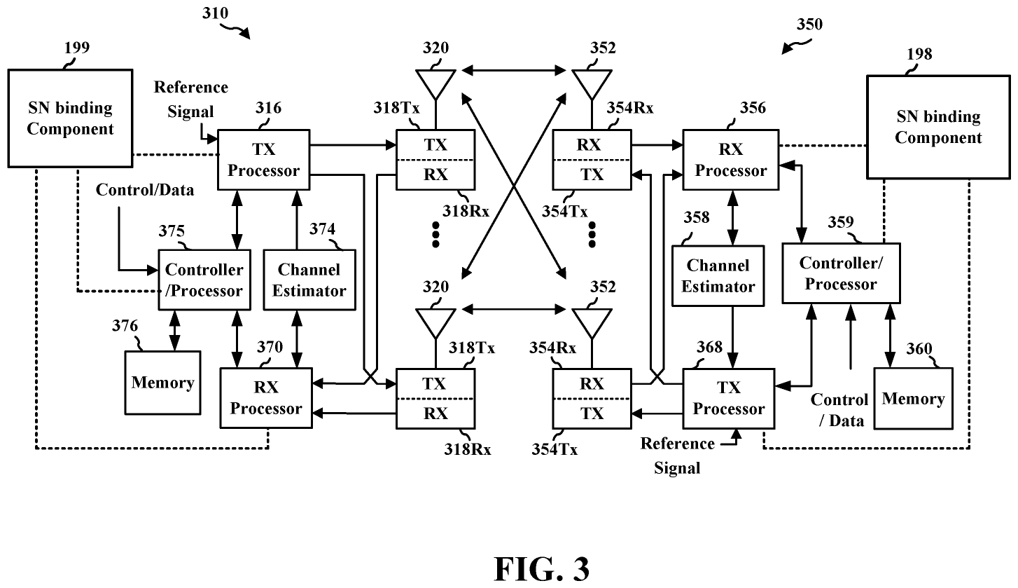

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the SN binding component 198 of FIG. 1.

At least one of the TX processor 316, the RX processor 370, and the controller/processor 375 may be configured to perform aspects in connection with the SN binding component 199 of FIG. 1.

Wireless communication systems may support various types of traffic. As an example of a type of traffic that may be supported by a wireless network, XR traffic may refer to wireless communications for technologies such as virtual reality (VR), mixed reality (MR), and augmented reality (AR). VR may refer to technologies in which a user is immersed in a simulated experience that is similar or different from the real world. A user may interact with a VR system through a VR headset or a multi-projected environment that generates realistic images, sounds, and other sensations that simulate a user's physical presence in a virtual environment. MR may refer to technologies in which aspects of a virtual environment and a real environment are mixed. AR may refer to technologies in which objects residing in the real world are enhanced via computer-generated perceptual information, sometimes across multiple sensory modalities, such as visual, auditory, haptic, somatosensory, and/or olfactory. An AR system may incorporate a combination of real and virtual worlds, real-time interaction, and accurate three-dimensional registration of virtual objects and real objects. In some examples, an AR system may overlay sensory information (e.g., images) onto a natural environment and/or mask real objects from the natural environment. XR traffic may include video data and/or audio data. XR traffic may be transmitted by a base station and received by a UE, or the XR traffic may be transmitted by a UE and received by a base station.

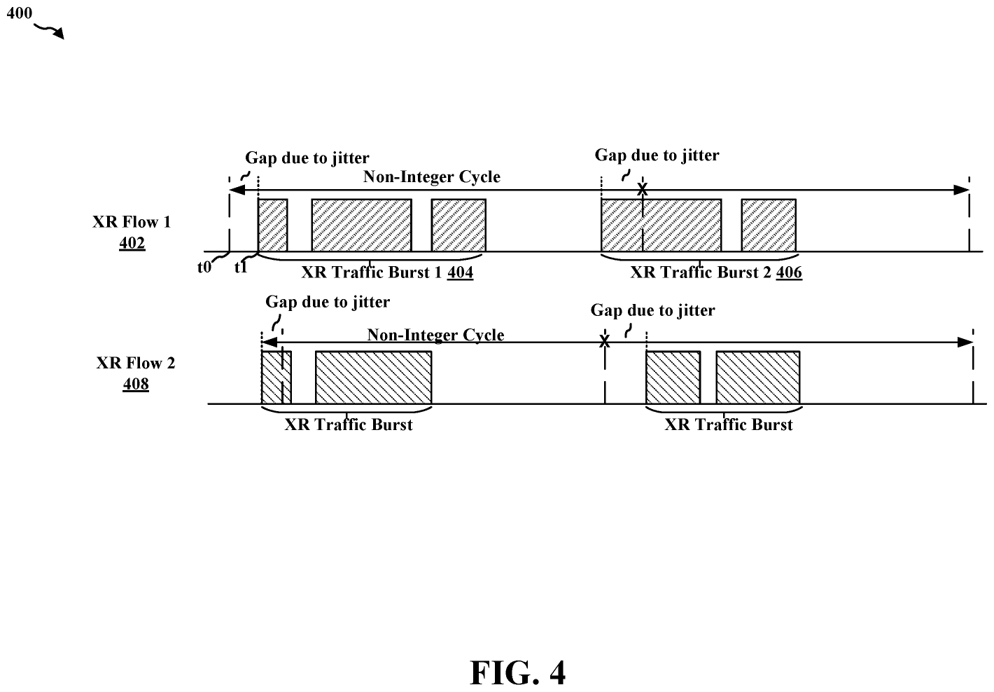

XR traffic may arrive in periodic traffic bursts (“XR traffic bursts” or “XR bursts”). An XR traffic burst may vary in a number of packets per burst and/or the size of each pack in the burst. The diagram 400 in FIG. 4 illustrates a first XR flow 402 that includes a first XR traffic burst 404 and a second XR traffic burst 406. As illustrated in the diagram 400, the traffic bursts may include different numbers of packets. For example, the first XR traffic burst 404 is shown with three packets (represented as rectangles in the diagram 400) and the second XR traffic burst 406 is shown with two packets. Furthermore, as illustrated in the diagram 400, the three packets in the first XR traffic burst 404 and the two packets in the second XR traffic burst 406 may vary in size. That is, packets within the first XR traffic burst 404 and the second XR traffic burst 406 may include varying amounts of data.

XR traffic bursts may arrive at non-integer periods (i.e., in a non-integer cycle). The periods may differ from an integer number of symbols, slots, etc. In one example, for 60 frames per second (FPS) video data, XR traffic bursts may arrive in 1/60=16.67 ms periods. In another example, for 120 FPS video data, XR traffic bursts may arrive in 1/120=8.33 ms periods.

Arrival times of XR traffic may vary. For example, XR traffic bursts may arrive and be available for transmission at a time that is earlier or later than the time at which a UE (or a base station) expects the XR traffic bursts. The variability of the packet arrival relative to the period (e.g., 16.76 ms period, 8.33 ms period, etc.) may be referred to as “jitter.” In one example, jitter for XR traffic may range from-4 ms (earlier than expected arrival) to +4 ms (later than expected arrival). For instance, referring to the first XR flow 402, a UE may expect a first packet of the first XR traffic burst 404 to arrive at time t0, but the first packet of the first XR traffic burst 404 arrives at time t1.

XR traffic may include multiple flows that arrive at a UE (or a base station) concurrently with one another (or within a threshold period of time). For instance, the diagram 400 includes a second XR flow 408. The second XR flow 408 may have different characteristics than the first XR flow 402. For instance, the second XR flow 408 may have XR traffic bursts with different numbers of packets, different sizes of packets, etc. In one example, the first XR flow 402 may include video data, and the second XR flow 408 may include audio data for the video data. In another example, the first XR flow 402 may include intra-coded picture frames (I-frames) that include complete images, and the second XR flow 408 may include predicted picture frames (P-frames) that include changes from a previous image.

Example aspects presented herein provide methods and apparatus for PDCP and RLC SNs binding. This binding enhances user plane performance for data packet transmission in wireless communication, including communication for XR applications. In some aspects, the binding may be a one-on-one binding between PDCP SN and RLC SN (e.g., via an offset between the PDCP SN and the corresponding RLC SN) at RLC configuration during the establishment of RLC. For a received PDCP SN (which may be referred to as PDCP_SN), if the PDCP SN's binding RLC SN (which may be referred to as f(PDCP_SN), with f representing the binding relationship) exceeds a subsequent RLC SN (which may be referred to as Rx_Next), the UE may adjust Rx_Next to be the first SN greater than or equal to f(PDCP_SN), where all segments corresponding to the SN have not been received. Additionally, in the situations where a PDCP PDU may be lost, the transmitter may inform the receiver about a change in SN binding by indicating a new offset or by including two bits in the data PDU RLC header to indicate whether the SN is present and whether the receiver should utilize the mapping between the PDCP and RLC SNs. For situations involving dual connectivity (DC), the RLC header may include a new header that informs the receiver about the gap between the PDCP SN of the current transmission and that of the previous transmission on the same RLC leg.

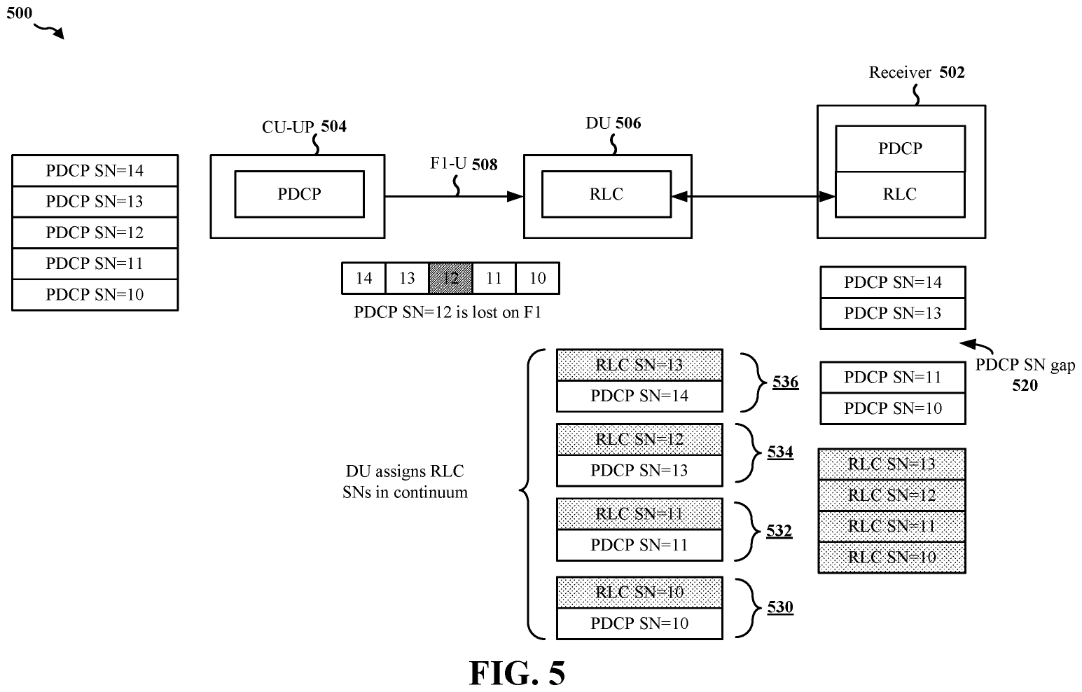

In wireless communication, the PDCP layer and the RLC layer may use SNs to facilitate the transmission of data packets. For example, each data packet prepared for transmission in the PDCP layer may be assigned a SN (a PDCP SN). These PDCP SNs may be used to ensure the integrity of the data transmission, including the proper order of the data packets. However, during the data transmission, gaps in PDCP SNs may occur on the receiver (e.g., a UE), as a result of, for example, data loss or delay or the variations in transmission rate (e.g., in scenarios involving dual connectivity). FIG. 5 is a diagram 500 illustrating an example of a gap in the PDCP SNs caused by the loss of a data packet (e.g., which may occur based on an F1 loss or a PDCP discard). In the example of FIG. 5, data packets are assigned PDCP SNs at the PDCP layer, such as PDCP SN=10, 11, 12, 13, and 14. During the transmission from CU-UP 504 to the DU 506 over the F1 interface 508, the data packet with PDCP SN of 12 may be lost. On the other hand, the DU 506 may assign RLC SNs in sequence, for example, RLC SN=10, 11, 12, and 13. Due to the loss of the data packet associated with PDCP SN of 12, a PDCP SN gap 520 may emerge at the receiver 502. The PDCP SN gap 520 may cause unnecessary waiting for reordering, a process of rearranging out-of-sequence packets into the correct sequence before delivery. For example, if an SN is missed, e.g., an SN gap occurs as illustrated at 520, the receiver may wait until a reordering timer expires before moving to other SNs.

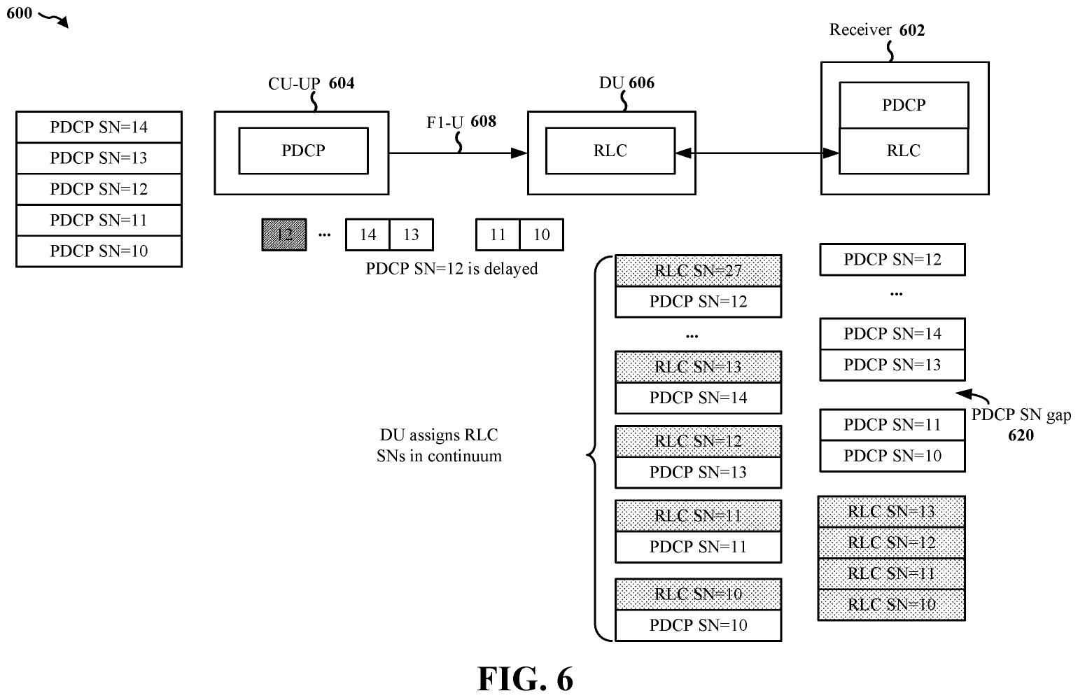

FIG. 6 is a diagram 600 illustrating an example of a gap in the PDCP SNs that may be caused by the delay of a data packet (e.g., an F1 delay). In the example of FIG. 6, data packets are assigned PDCP SNs at the PDCP layer, such as PDCP SN=10, 11, 12, 13, and 14, similar to the example in FIG. 5. During the transmission from CU-UP 604 to the DU 606 over the F1 interface 608, the data packet with PDCP SN of 12 may be delayed. As the DU 606 assigns RLC SNs in sequence, for example, RLC SN=10, 11, 12, and 13, the delayed data packet (data packet associated with PDCP SN of 12) may be associated with a later RLC SN (e.g., RLC SN of 27). Due to the delay of the data packet associated with PDCP SN 12, a PDCP SN gap 620 may emerge at the receiver 602.

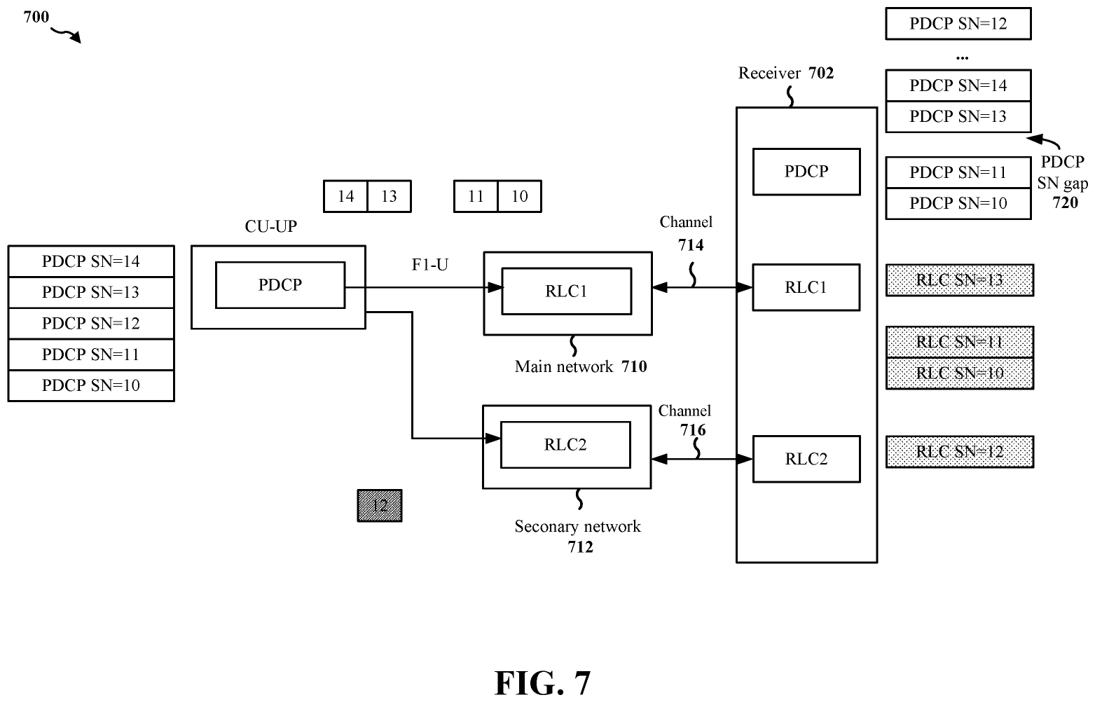

FIG. 7 is a diagram 700 illustrating an example of a gap in the PDCP SNs due to the variations on the data transmission rate. As an example, the gap may be caused by an asymmetric dual connectivity (DC). In the example of FIG. 7, data packets are assigned PDCP SNs at the PDCP layer, such as PDCP SN=10, 11, 12, 13, and 14, similar to the example in FIG. 5. In FIG. 7, the network may operate in a dual connectivity mode, and a portion of the data packets, such as those associated with PDCP SNs 10, 11, 13, and 14 may be transmitted via the main network 710, while another portion of the data packets, such as the data packet associated with PDCP SN of 12, may be transmitted via the secondary network 712. The data packets transmitted via different channels (e.g., channels 714 and 716) may arrive at the receiver 702 at different times. For example, if channel 716 has worse channel condition than channel 714, the data packet associated with PDCP SN 12 may arrive at the receiver 702 later than the data packets transmitted over channel 714. As a result, a PDCP SN gap 720 may emerge at the receiver 502.

Due to a lack of information on the causes of the gaps in the PDCP SNs on the receiving end, the PDCP SN gaps may incur unnecessary RLC retransmission and/or waiting at the receiver. Such retransmission may significantly impact the latency of wireless communication and is particularly detrimental for latency-sensitive applications, such as extended reality (XR) applications. Example aspects presented herein provide methods and apparatus to inform the receiver of the SN gaps or missing SNs in the PDCP layer to minimize unnecessary RLC retransmission.

In some aspects, a one-on-one mapping (or binding) may be established between the PDCP SNs and the RLC SNs at the time of RLC configuration during the RLC establishment. This one-on-one mapping (or binding) may enable the receiver (e.g., a UE) to deduce the RLC SN from the PDCP SN and vice versa. In some examples, the mapping (or binding relationship) between the PDCP and RLC SNs may be changed, for example, in the scenarios of PDCP data loss. In some examples, the mapping (or binding relationship) between the PDCP and RLC SNs may be applicable to scenarios involving dual connectivity.

In some examples, the binding relationship between the PDCP and RLC SNs may include that the PDCP and RLC SNs use the same SNs, until the network indicates a change to the binding relationship. For example, referring to FIG. 5, PDCP SN of 10 may map to the RLC SN of 10 at 530, and the PDCP SN of 11 may map to the RLC SN of 11 at 532. In some examples, the binding relationship between the PDCP and RLC SNs may include that the PDCP SN and the corresponding RLC SNs have a configurable offset. For example, referring to FIG. 5, after the data loss of the data packet associated with the PDCP SN of 12, the PDCP SN and the mapping RLC SN may have an offset of 1. For example, PDCP SN of 13 may map to the RLC SN of 12 at 534, and the PDCP SN of 14 may map to the RLC SN of 13 at 536. To facilitate the implementation of the binding relationship between the PDCP and RLC SNs, the PDCP SNs and RLC SNs may use the same SN size. For example, for RLC unacknowledged mode (UM), both PDCP and RLC SNs may use 12 bits for the SNs, and for RLC acknowledged mode (AM), both PDCP and RLC SNs may use either 12 or 18 bits for the SNs.

In some aspects, based on the binding relationship between the PDCP and RLC SN, unnecessary RLC retransmission may be reduced. For example, based on the binding relationship between the PDCP and RLC SNs, a UE may map the PDCP reordering window to RLC SNs. In some examples, based on the RLC SNs and the mapping relationship, the UE may determine whether a PDCP reordering window has moved on. If the PDCP reordering window has moved on, the RLC packets may be acknowledged (ACKed), effectively avoiding unnecessary RLC retransmissions. As used herein, a “PDCP reordering window” may refer to a window for managing out-of-order data packets and handling duplications. When a PDCP reordering window has “moved on,” it means the reordering window has advanced to accept newer packets, and the packets outside of this updated window are considered too old to be reordered and may be dropped or ignored.

In some examples, when the PDCP reordering window moves (e.g., upon the expiration of the PDCP reordering timer), the receiver (e.g., the UE) may treat RLC SNs corresponding to PDCP SNs less than the delivered PDCP SN (denoted as RX_Deliv) as having been successfully received at the RLC layer. For example, assuming the receiver (e.g., the UE) has a mapping relationship f that maps a PDCP SN (e.g., PDCP_SN) to a corresponding RLC SN (e.g., RLC_SN). That is, the mapping relationship may be expressed as: RLC_SN=f(PDCP_SN). In the RLC layer, when a PDCP SN (e.g., PDCP_SN) maps to an RLC SN (e.g., f(PDCP_SN)) that exceeds the next received RLC SN, denoted as Rx_Next, based on the mapping function, the UE may consider the PDCP recording window has moved on and update the next received RLC SN (e.g., Rx_Next) to the first SN that is both greater than or equal to f(PDCP_SN) and for which not all segments have been received.

In some examples, when the UE determines the PDCP reordering window has moved on, the reassembly timer may be updated accordingly. This mechanism ensures that RLC packets are acknowledged (ACKed) by the RLC layer when the PDCP reordering window moves on, effectively avoiding unnecessary RLC retransmissions. As used herein, a “reassembly timer” is defined as a countdown timer maintained at the RLC when operating in acknowledge mode (AM). The reassembly timer starts when an RLC SN gap is detected and stops once all RLC SN gaps are filled. The reassembly timer may expire and cause an RLC status report to be transmitted. In RLC unacknowledged mode (UM), the expiration of the reassembly timer may cause the RLC window to advance and incomplete PDUs to be discarded. A “PDCP reordering timer” is defined as a countdown timer that starts when the first out-of-order packet is detected. If the missing packets do not arrive within the timer's duration, the reordering window is moved on, and packets outside the window are discarded.

In some aspects, disruptions such as data packet loss or delay in the PDCP layer may invalidate the previously established binding relationship between the PDCP and RLC SNs. For example, referring to FIG. 5, when a data packet (e.g., a PDCP protocol data unit (PDU)) is lost during transmission on the F1 interface, such as the data packet associated with PDCP SN 12, the offset between the PDCP SN and the corresponding RLC SN may change from 0 (e.g., for the mapping at 530 and 532) to 1 (e.g., for the mapping at 534 and 536). In some examples, when the distribution unit (DU) RLC detects the loss of a PDU, it may send a dummy PDU to maintain the existing binding relationship between the PDCP and RLC SNs.

In some examples, when there is an update to the binding relationship (e.g., there is a change of the offset, as shown in FIG. 5), the transmitter may communicate the update to the binding relationship to the receiver (e.g., a UE). In some examples, when the binding relationship has changed, the transmitter may inform the change in the binding relationship to the receiver (e.g., a UE) by signaling a new offset between a PDCP SN and a corresponding RLC SN. For example, if the binding relationship changes from RLC_SN=f(PDCP_SN) to RLC_SN=f(PDCP_SN)+1 as a result of a PDU loss on F1 interface (e.g., the loss of PDCP SN 12), the transmitter may indicate to the receiver (e.g., the UE) of this adjustment by indicating a new offset of 1 (ΔSN=1), thereby updating the receiver (e.g., the UE) on the revised binding. The transmitter may indicate to the receiver (e.g., the UE) the update through various means, including the signaling between the transmitter and receiver (e.g., the UE) based on, for example, radio resource control (RRC) signaling, medium access control (MAC) signaling, RLC control signaling, or PDCP control signaling.

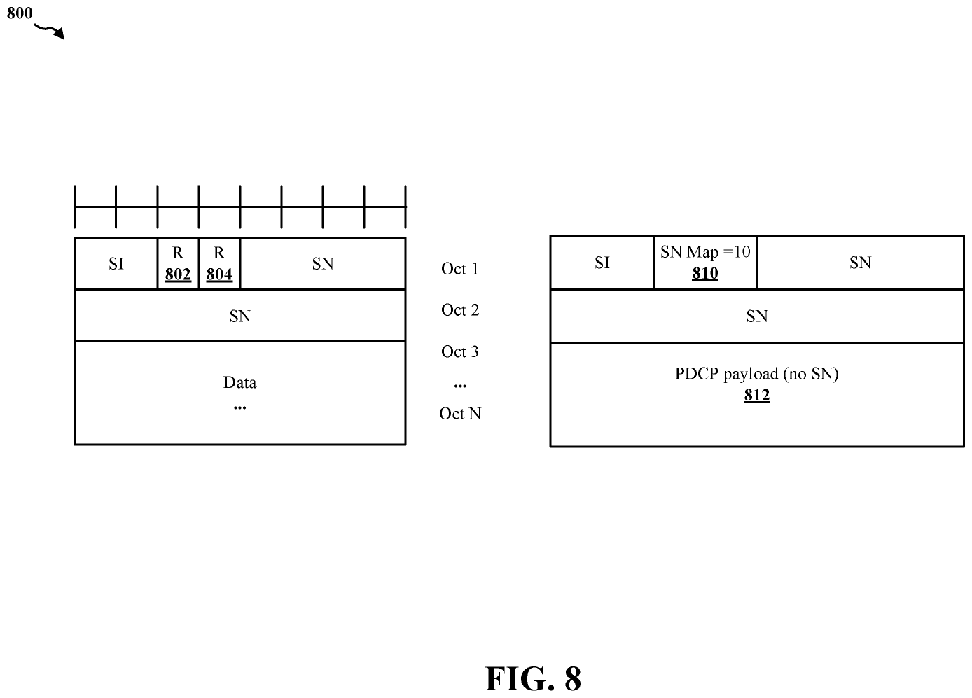

In some aspects, the binding relationship between the PDCP and RLC SNs may be based on implicit mapping. In some examples, the implicit mapping may be indicated by the data protocol data unit (PDU) RLC header. FIG. 8 is a diagram 800 illustrating an example of an RLC header indicating the PDCP and RLC SN binding in accordance with various aspects of the present disclosure. As shown in FIG. 8, a field (e.g., the SN Map field 810) in the data PDU RLC header may be used to indicate whether the PDCP SN is present and whether the receiver (e.g., the UE) may apply the mapping. In some examples, the SN Map field 810 may be a 2-bit field and may occupy the places of the reserved bits 802 and 804 in the original RLC header. Table 2 shows example values of the SN Map field 810. As shown in Table 2, the value of the SN Map field 810 may indicate whether the PDCP SNs are present (e.g., the value of “00” or “01” may indicate the presence of the PDCP SNs, while the value of “10” may indicate the absence of the PDCP SNs), whether there is an establishment of the mapping relationship (e.g., the value of “01” may indicate the establishment of the mapping relationship), and whether there is a usage or continuation of a previously established mapping relationship (e.g., the value of “00” may indicate the mapping relationship is not used, while the value of “10” may indicate the usage of a previous established mapping relationship). When the SN Map field has the value of “10,” indicating the absence of the PDCP SN and the usage of a previously established mapping relationship, the PDCP payload 812 may not contain the PDCP SN, as the PDCP SN may be inferred by the receiver based on the RLC SN and the mapping relationship.

TABLE 2
Example Values of the SN Map Field

| “SN Map” | |
|---|---|
| field value | Description |
| 00 | PDCP SN present, no current PDCP/RLC |
| | SN mapping needed |
| 01 | PDCP SN present, the receiver should store |
| | the current PDU mapping. The transmitter |
| | is expected to use this format before the |
| | PDCP SN is removed |
| 10 | PDCP SN absent, the receiver should infer |
| | PDCP SN from last stored mapping and |
| | RLC SN |
| 11 | Reserved |

In some aspects, the binding relationship between the PDCP and RLC SNs may be used in communication that involves dual connectivity (DC), particularly with RLC in acknowledged mode (AM). Unlike the scenario with RLC in unacknowledged mode (UM) in dual connectivity, where the RLC may use non-contiguous SNs without any adverse effect, the RLC SNs in RLC AM are continuous and a gap (or hole) in the RLC SNs may cause the reassembly timer to start and the RLC receiver (e.g., the UE) may not move the window until the RLC PDU missing in the sequence is successfully received, which may complicate the data transmission.

In some aspects, to enable the binding relationship between the PDCP and RLC SNs for dual connectivity communication, the RLC header may include a field that informs information about the gap, denoted as Δ_{PDCP_SN}, between the current PDCP SN and the previous PDCP SN (e.g., the gap of PDCP SNs between consecutive PDCP transmissions) over the same RLC leg. This information may enable the UE to track any losses that may occur on an RLC leg, thereby facilitating a more accurate mapping of these losses into the RLC SNs.

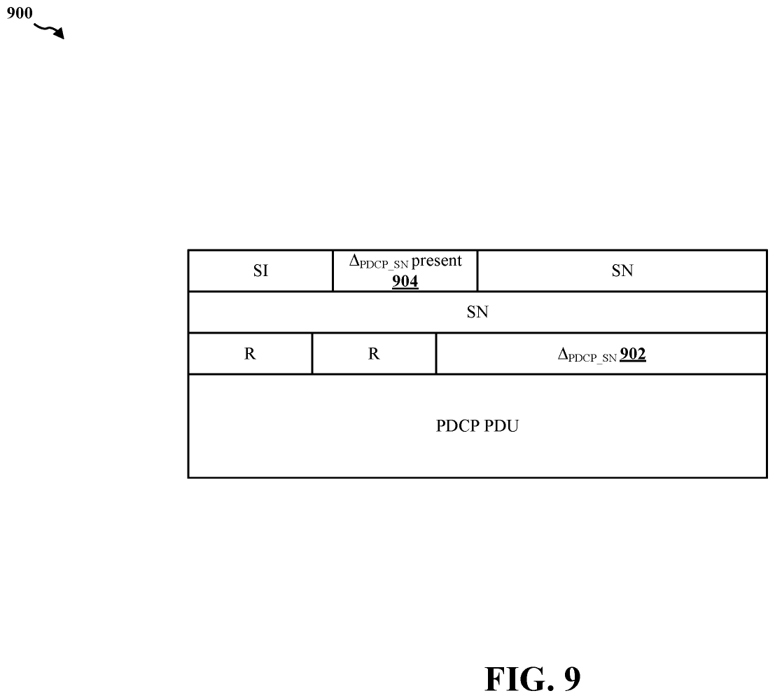

FIG. 9 is a diagram 900 illustrating an example RLC header indicating the gaps between PDCP SNs of consecutive PDCP transmissions in DC communication. As shown in FIG. 9, a new field (e.g., Δ_{PDCP_SN} 902) in the RLC header may provide information about the gaps of the PDCP SNs between consecutive PDCP transmissions over the same RLC leg (e.g., over the channel 714 or 716).

In some examples, the RLC header may further include a filed (e.g., 904) to indicate whether the RLC header includes the field Δ_{PDCP_SN} 902. For example, a value of “0000” for the field 904 may indicate that the transmitter does not include the field APDCP_SN 902 in the RLC header (e.g., to circumvent issues related to sequence number wraparound). In some examples, when the RLC header includes a field (e.g., 904) that explicitly indicates the presence or absence of the Δ_{PDCP_SN} (e.g., Δ_{PDCP_SN} 902) within it, the field Δ_{PDCP_SN} 902 may occupy up to 6 bits. The information provided by the field Δ_{PDCP_SN} 902 may allow the UE to map its PDCP SN buffer with the corresponding RLC SNs, and enables the UE to acknowledge the remaining SNs that are outside of the reordering window, thereby reducing unnecessary data transmissions.

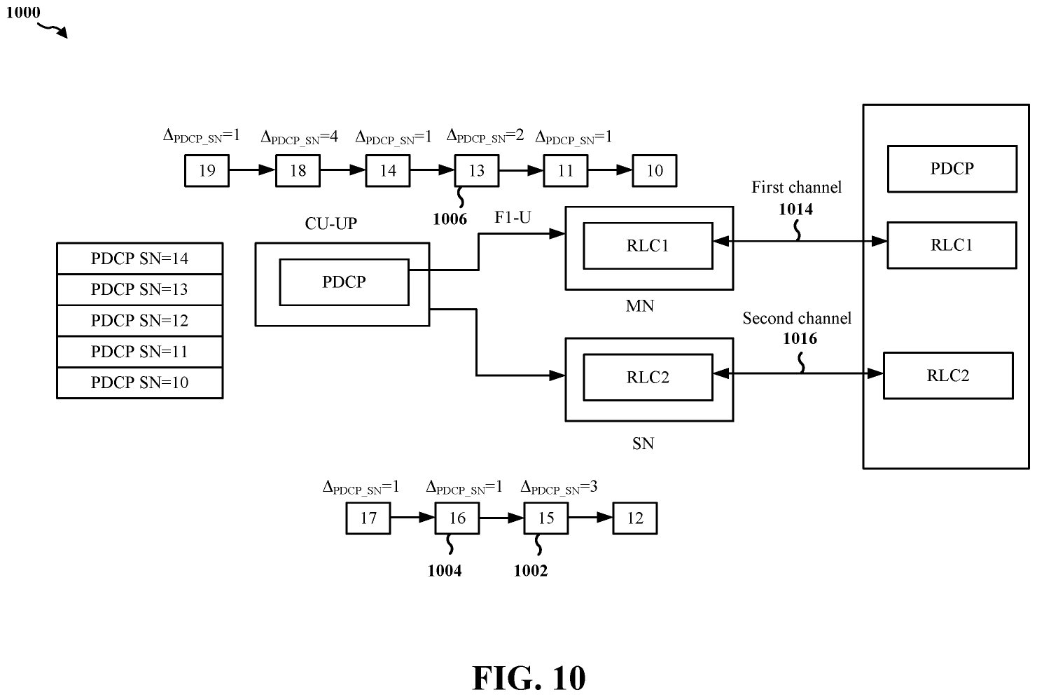

FIG. 10 is a diagram 1000 illustrating example values of the gaps between PDCP SNs of consecutive PDCP transmissions in DC communication. As shown in FIG. 10, in DC communication that involves the first channel 1014 and the second channel 1016, some data packets (e.g., data packets associated with PDCP SNs 10, 11, 13, 14, 18 and 19) may be transmitted via the first channel 1014, while other data packets (e.g., data packets associated with PDCP SNs 12, 15, 16, and 17) may be transmitted via the second channel 1016. The RLC header associated each PDCP SNs may include the field Δ_{PDCP_SN} 902 that indicates the gaps between the PDCP SNs of the current PDCP transmission and the previous PDCP transmission transmitted on the same RLC entity, logical entity, or cell group. For example, as shown in FIG. 10, the RLC header associated PDCP SN 15 (at 1002) may include the field Δ_{PDCP_SN} 902 having a value of 3, indicating that the gap between the PDCP SN of the current PDCP transmission (e.g., 15) and the PDCP SN of the previous PDCP transmission (e.g., 12) is 3. Similarly, the RLC header associated PDCP SN 16 (at 1004) may include the field Δ_{PDCP_SN} 902 having a value of 1, indicating that the gap between the PDCP SN of the current PDCP transmission (e.g., 16) and the PDCP SN of the previous PDCP transmission (e.g., 15) is 1. The RLC header associated PDCP SN 13 (at 1006) may include the field Δ_{PDCP_SN} 902 having a value of 2, indicating that the gap between the PDCP SN of the current PDCP transmission (e.g., 13) and the PDCP SN of the previous PDCP transmission (e.g., 11) is 2.

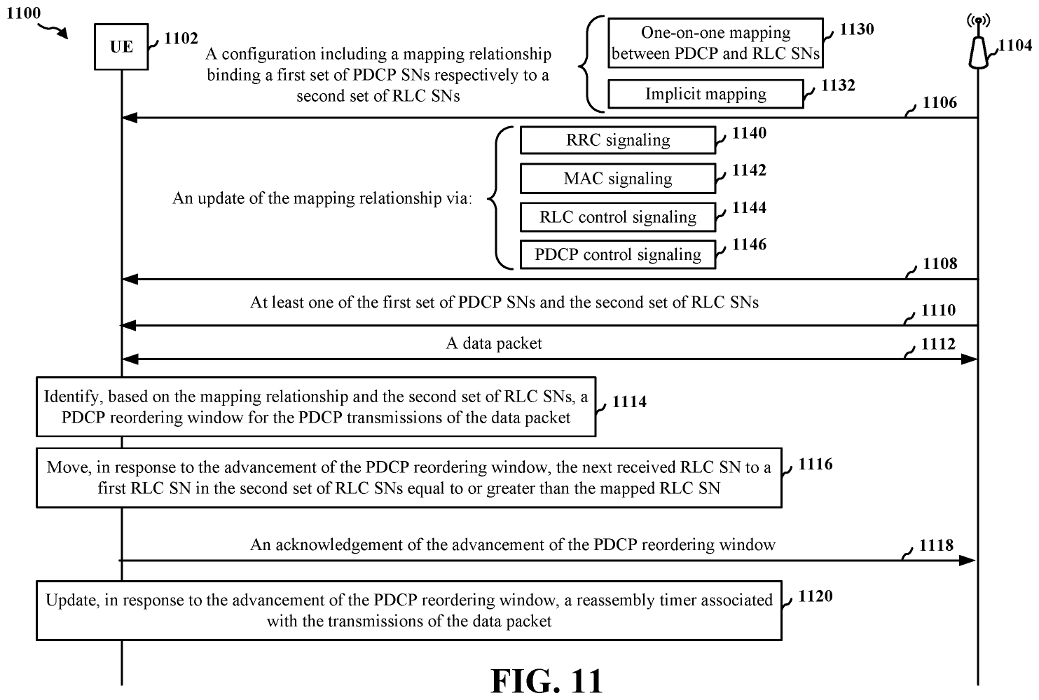

FIG. 11 is a call flow diagram 1100 illustrating a method of wireless communication in accordance with various aspects of this present disclosure. Various aspects are described in connection with a UE 1102 and a base station 1104. The aspects may be performed by the UE 1102 or the base station 1104 in aggregation and/or by one or more components of a base station 1104 (e.g., a CU 110, a DU 130, and/or an RU 140).

As shown in FIG. 11, a UE 1102 may receive, at 1106 from base station 1104, a configuration including a mapping relationship binding a set of PDCP SNs respectively to a set of RLC SNs. In some examples, the mapping relationship may be a one-on-one mapping between the PCDP and RLC SNs (at 1130). For example, referring to FIG. 5, the mapping relationship may include the mapping of PDCP SN 10 to RLC SN 10 (at 530) and the mapping of PDCP SN 11 to RLC SN 11 (at 532). In some examples, the mapping relationship may be implicit mapping (at 1132). For example, referring to FIG. 8, an RLC header may include the SN Map field 810, which may indicate the present of the mapping between the PDCP SN and RLC SN.

At 1108, the UE 1102 may receive an update of the mapping relationship from the base station 1104. For example, the update of the mapping relationship may include an adjustment to the offset corresponding to the mapping between the PDCP and RLC SNs. For example, referring to FIG. 5, due to the data loss associated with PDCP SN 12, the base station may indicate to the UE to change the offset between the PDCP and RLC SNs from 0 (e.g., for mapping at 530 and 532) to 1 (for mapping at 534 and 536). In some examples, the UE 1102 may receive the update via one of: RRC signaling (at 1140), MAC signaling (at 1142), RLC control signaling (at 1144), or PDCP control signaling (at 1146).

At 1110, the UE 1102 may receive at least one of the first set of PDCP SNs and the second set of RLC SNs. The first set of PDCP SNs respectively correspond to PDCP transmissions of the data packet, and the second set of RLC SNs respectively correspond to RLC transmissions of the data packet. For example, referring to FIG. 5, the receiver 502 may receive data packets associated with PDCP SNs of 10, 11, 13, and 14 and RLC SNs of 10, 11, 12, and 13.

At 1112, the UE 1102 may communicate, based on the mapping relationship (received at 1106), a data packet with the base station 1104. For example, referring to FIG. 5, the base station (e.g., DU 506) and the UE (e.g., receiver 502) may communicate a data packet (e.g., data packets associated with PDCP SNs of 10, 11, 13, and 14 and RLC SNs of 10, 11, 12, and 13) based on the mapping relationship.

At 1114, the UE 1102 may identify, based on the mapping relationship and the second set of RLC SNs, a PDCP reordering window for the PDCP transmissions of the data packet.

At 1116, the UE 1102 may move, in response to the advancement of the PDCP reordering window, the next received RLC SN to a first RLC SN in the second set of RLC SNs equal to or greater than the mapped RLC SN. The first RLC SN corresponds to the RLC transmissions that have not been received. For example, assuming the UE has a mapping relationship f that maps a PDCP SN (e.g., PDCP_SN) to a corresponding RLC SN (e.g., RLC_SN) via RLC_SN=f(PDCP_SN), in the RLC layer, when a PDCP SN (e.g., PDCP_SN) maps to an RLC SN (e.g., f(PDCP_SN)) that exceeds the next received RLC SN (e.g., Rx_Next), the UE may consider the PDCP recording window has moved on and move the next received RLC SN (e.g., Rx_Next) to the first SN that is both greater than or equal to f(PDCP_SN) and for which not all RLC transmissions have been received.

At 1118, the UE 1102 may transmit, for the base station 1104, an acknowledgement of the advancement of the PDCP reordering window. For example, based on the binding relationship between the PDCP and RLC SNs, when the PDCP reordering windows moves on, RLC packets are acknowledged (ACKed) by the RLC layer.

At 1120, the UE 1102 may update, in response to the advancement of the PDCP reordering window, a reassembly timer associated with the transmissions of the data packet.

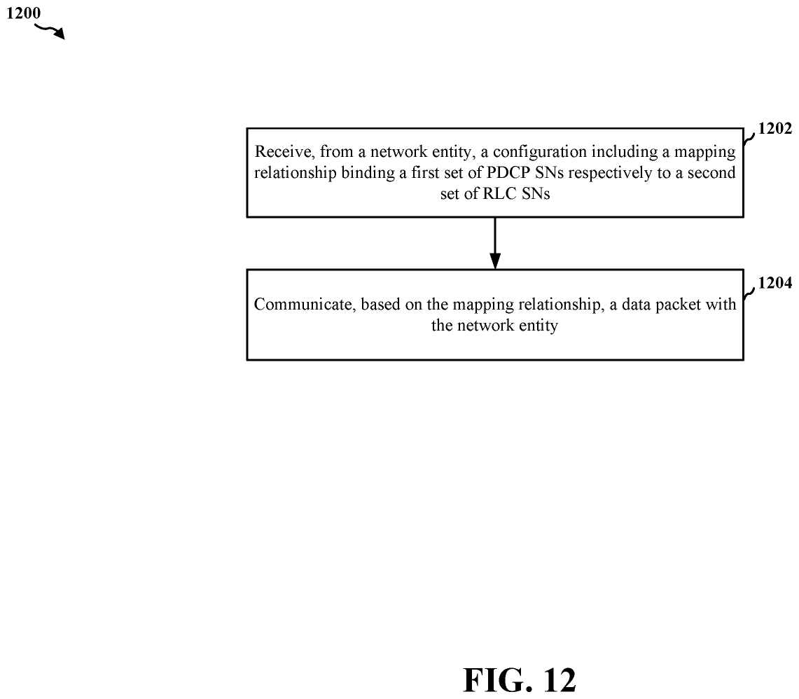

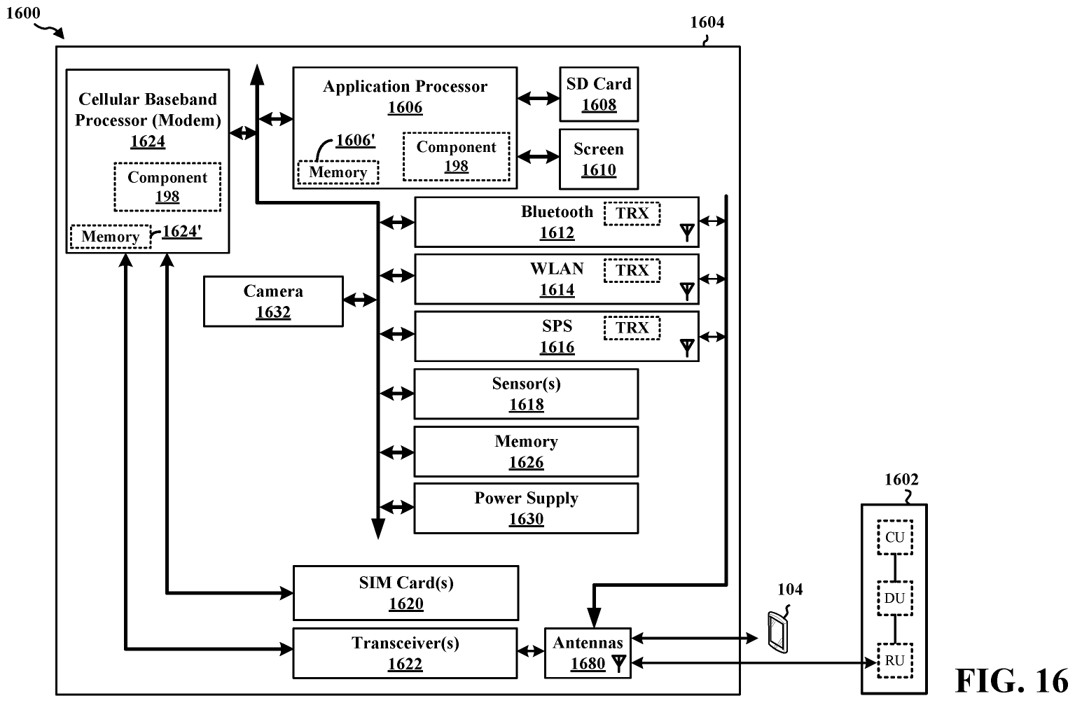

FIG. 12 is a flowchart 1200 illustrating methods of wireless communication at a UE in accordance with various aspects of the present disclosure. The method may be performed by a UE. The UE may be the UE 104, 350, 1102, or the apparatus 1604 in the hardware implementation of FIG. 16. Based on a binding relationship between PDCP SNs and RLC SNs, the methods enable the UE to map the PDCP reordering window to RLC SNs and vice versa to improve the handling of packet loss (e.g., packet loss on F1 interface) and reordering and reduce unnecessary RLC retransmission, thereby improving reliability and efficiency of wireless communication. Additionally, by allowing the tracking of losses and adjustments in the binding relationship, the methods ensure that data transmission remains efficient and reliable even in complex network configurations, such as dual connectivity.

As shown in FIG. 12, at 1202, the UE may receive, from a network entity, a configuration including a mapping relationship binding a first set of PDCP SNs respectively to a second set of RLC SNs. The network entity may be a base station, or a component of a base station, in the access network of FIG. 1 or a core network component (e.g., base station 102, 310, 1104; or the network entity 1602 in the hardware implementation of FIG. 16). FIG. 8, FIG. 10, FIG. 9, and FIG. 11 illustrate various aspects of the steps in connection with flowchart 1200. For example, referring to FIG. 11, at 1106, the UE 1102 may receive, from a network entity (base station 1104), a configuration including a mapping relationship binding a first set of PDCP SNs respectively to a second set of RLC SNs. In some aspects, 1202 may be performed by the SN binding component 198.

At 1204, the UE may communicate, based on the mapping relationship, a data packet with the network entity. For example, referring to FIG. 11, the UE 1102 may, at 1112, communicate, based on the mapping relationship, a data packet with the network entity (base station 1104). In some aspects, 1204 may be performed by the SN binding component 198.

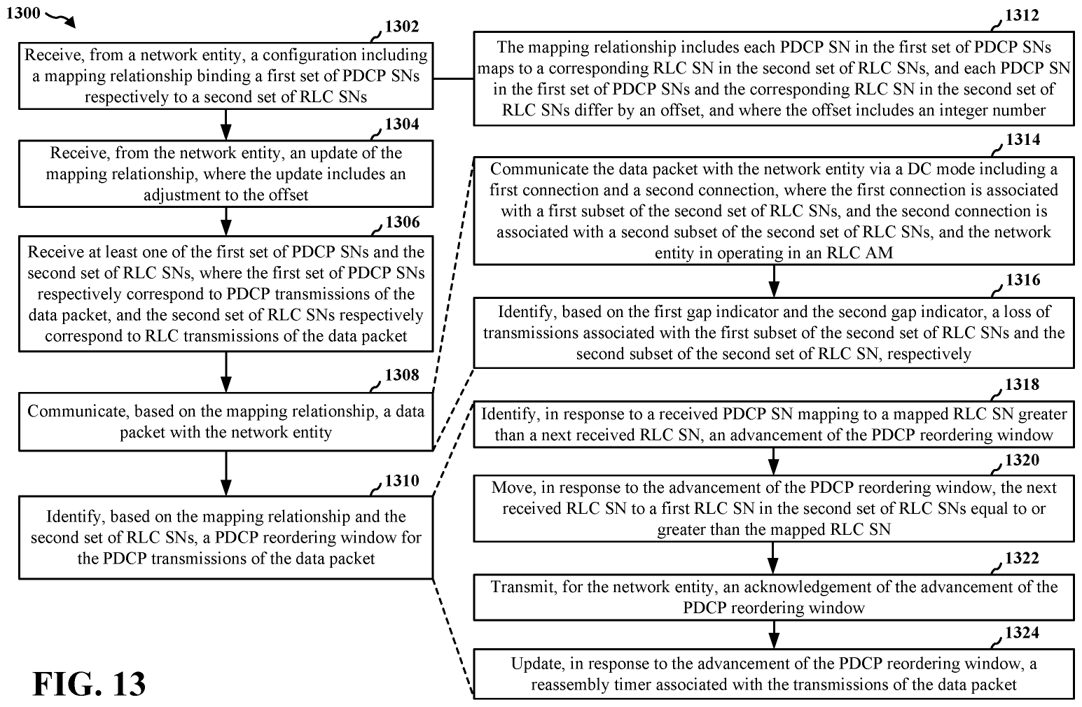

FIG. 13 is a flowchart 1300 illustrating methods of wireless communication at a UE in accordance with various aspects of the present disclosure. The method may be performed by a UE. The UE may be the UE 104, 350, 1102, or the apparatus 1604 in the hardware implementation of FIG. 16. Based on a binding relationship between PDCP SNs and RLC SNs, the methods enable the UE to map the PDCP reordering window to RLC SNs and vice versa to improve the handling of packet loss (e.g., packet loss on F1 interface) and reordering and reduce unnecessary RLC retransmission, thereby improving reliability and efficiency of wireless communication. Additionally, by allowing the tracking of losses and adjustments in the binding relationship, the methods ensure that data transmission remains efficient and reliable even in complex network configurations, such as dual connectivity.

As shown in FIG. 13, at 1302, the UE may receive, from a network entity, a configuration including a mapping relationship binding a first set of PDCP SNs respectively to a second set of RLC SNs. The network entity may be a base station, or a component of a base station, in the access network of FIG. 1 or a core network component (e.g., base station 102, 310, 1104; or the network entity 1602 in the hardware implementation of FIG. 16). FIG. 8, FIG. 10, FIG. 9, and FIG. 11 illustrate various aspects of the steps in connection with flowchart 1200. For example, referring to FIG. 11, at 1106, the UE 1102 may receive, from a network entity (base station 1104), a configuration including a mapping relationship binding a first set of PDCP SNs respectively to a second set of RLC SNs. In some aspects, 1302 may be performed by the SN binding component 198.

At 1308, the UE may communicate, based on the mapping relationship, a data packet with the network entity. For example, referring to FIG. 11, the UE 1102 may, at 1112, communicate, based on the mapping relationship, a data packet with the network entity (base station 1104). In some aspects, 1308 may be performed by the SN binding component 198.

In some aspects, at 1306, the UE may receive at least one of the first set of PDCP SNs and the second set of RLC SNs. The first set of PDCP SNs respectively correspond to PDCP transmissions of the data packet, and the second set of RLC SNs respectively correspond to RLC transmissions of the data packet. For example, referring to FIG. 11, at 1110, the UE may receive at least one of the first set of PDCP SNs and the second set of RLC SNs. The first set of PDCP SNs respectively correspond to PDCP transmissions of the data packet, and the second set of RLC SNs respectively correspond to RLC transmissions of the data packet. For example, referring to FIG. 5, the UE (receiver 502) may receive data packets associated with PDCP SNs of 10, 11, 13, and 14 and RLC SNs of 10, 11, 12, and 13. In some aspects, 1306 may be performed by the SN binding component 198.

In some aspects, the data packet may be associated with an extended reality (XR) application. For example, referring to FIG. 11, the data packet (at 1112) may be associated with an XR application.

In some aspects, at 1312, the mapping relationship may include each PDCP SN in the first set of PDCP SNs maps to a corresponding RLC SN in the second set of RLC SNs, and each PDCP SN in the first set of PDCP SNs and the corresponding RLC SN in the second set of RLC SNs differ by an offset, and the offset may include an integer number. For example, referring to FIG. 11, the mapping relationship may be a one-on-one mapping (at 1130). Referring to FIG. 5, the mapping relationship may include the mapping of PDCP SN 10 to RLC SN 10 (at 530) or the mapping of PDCP SN 13 to RLC SN 12 (at 534), the offset between the PDCP SN and the corresponding RLC SN is zero (at 530) or 1 (at 534).

In some aspects, to communicate the data packet with the network entity (at 1308), the UE may identify, based on the mapping relationship and one of the first set of PDCP SNs and the second set of RLC SNs, a transmission status associated with the other one of the first set of PDCP SNs and the second set of RLC SN; and communicate, based on the transmission status, the data packet with the network entity. For example, referring to FIG. 11, UE 1102 may identify, at 1114, based on the mapping relationship and one of the first set of PDCP SNs and the second set of RLC SNs (e.g., the set of RLC SNs), a transmission status associated with the other one of the first set of PDCP SNs and the second set of RLC SN (e.g., the reordering window for PDCP transmissions).

In some aspects, at 1310, the UE may identify, based on the mapping relationship and the second set of RLC SNs, a PDCP reordering window for the PDCP transmissions of the data packet. For example, referring to FIG. 11, the UE 1102 may, at 1114, identify, based on the mapping relationship and the second set of RLC SNs, a PDCP reordering window for the PDCP transmissions of the data packet. In some aspects, 1310 may be performed by the SN binding component 198.

In some aspects, to identify the PDCP reordering window (at 1310), the UE may, at 1318, identify, in response to a received PDCP SN mapping to a mapped RLC SN greater than a next received RLC SN, an advancement of the PDCP reordering window. At 1320, the UE may move, in response to the advancement of the PDCP reordering window, the next received RLC SN to a first RLC SN in the second set of RLC SNs equal to or greater than the mapped RLC SN. The first RLC SN may correspond to the RLC transmissions that have not been received. For example, assuming the UE has a mapping relationship f that maps a PDCP SN (e.g., PDCP_SN) to a corresponding RLC SN (e.g., RLC_SN) via RLC_SN=f(PDCP_SN), when a PDCP SN (e.g., PDCP_SN) maps to an RLC SN (e.g., f (PDCP_SN)) that exceeds the next received RLC SN (e.g., Rx_Next), the UE may consider the PDCP recording window has moved on. The UE may update the next received RLC SN (e.g., Rx_Next) to the first SN that is both greater than or equal to f(PDCP_SN) and for which not all segments have been received. In some aspects, 1320 may be performed by the SN binding component 198.

In some aspects, at 1322, the UE may transmit, for the network entity, an acknowledgement of the advancement of the PDCP reordering window. For example, referring to FIG. 11, the UE 1102 may transmit, at 1118 for the network entity (base station 1104), an acknowledgement of the advancement of the PDCP reordering window. In some aspects, 1322 may be performed by the SN binding component 198.

In some aspects, at 1324, the UE may update, in response to the advancement of the PDCP reordering window, a reassembly timer associated with the transmissions of the data packet. For example, referring to FIG. 11, the UE 1102 may update, at 1120 in response to the advancement of the PDCP reordering window, a reassembly timer associated with the transmissions of the data packet. In some aspects, 1324 may be performed by the SN binding component 198.

In some aspects, at 1304, the UE may receive, from the network entity, an update of the mapping relationship. The update includes an adjustment to the offset. For example, referring to FIG. 11, the UE 1102 may receive, at 1108 from the network entity (base station 1104), an update of the mapping relationship. The update includes an adjustment to the offset (e.g., from the offset of 0 for 530 and 532 to the offset of 1 for 534 and 536). In some aspects, 1304 may be performed by the SN binding component 198.

In some aspects, the UE may receive the update to the mapping relationship (at 1304) via one of: RRC signaling, MAC signaling, RLC control signaling, or PDCP control signaling. For example, referring to FIG. 11, the UE 1102 may receive the update to the mapping relationship (at 1108) via one of: RRC signaling (at 1140), MAC signaling (at 1142), RLC control signaling (at 1144), or PDCP control signaling (at 1146).

In some aspects, the configuration including the mapping relationship may be included in a mapping field in an RLC header of a data protocol data unit (PDU) associated with the data packet. For example, referring to FIG. 8, the configuration including the mapping relationship may be included in a mapping field (e.g., SN Map field 810) in an RLC header of a data PDU associated with the data packet.

In some aspects, the mapping field may have a size of two bits and may indicate one or more of: the presence of the first set of PDCP SNs, the presence of the first set of PDCP SNs and an establishment of the mapping relationship between the first set of PDCP SNs and the second set of RLC SNs, or the usage or continuation of the mapping relationship between the first set of PDCP SNs and the second set of RLC SNs. For example, referring to FIG. 8 and Table 2, the mapping field (e.g., SN Map field 810) may have a size of two bits and may indicate the presence of the first set of PDCP SNs in (e.g., when SN Map field 810 has the value of “00,” as shown in Table 2), the presence of the first set of PDCP SNs and an establishment of the mapping relationship between the first set of PDCP SNs and the second set of RLC SNs, (e.g., when SN Map field 810 has the value of “01,” as shown in Table 2), or the usage of the mapping relationship between the first set of PDCP SNs and the second set of RLC SNs (e.g., when SN Map field 810 has the value of “10,” as shown in Table 2).

In some aspects, the configuration may further include a gap indication field indicating whether the RLC header includes a field indicating a gap between a current PDCP SN and a previous PDCP SN transmitted on the same RLC entity, logical entity, or cell group. For example, referring to FIG. 9, the configuration may further include a gap indication field (e.g., 904) indicating whether the RLC header includes a field (e.g., Δ_{PDCP_SN} 902) indicating a gap between a current PDCP SN and a previous PDCP SN transmitted on the same RLC entity, logical entity, or cell group.

In some aspects, to communicate the data packet with the network entity (at 1308), the UE may, at 1314, communicate the data packet with the network entity via a dual connectivity (DC) mode including a first connection and a second connection. The first connection may be associated with a first subset of the second set of RLC SNs, and the second connection may be associated with a second subset of the second set of RLC SNs. The network entity may be operating in an RLC AM. For example, referring to FIG. 10, the UE may communicate the data packet with the network entity via a DC mode, including a first connection (e.g., via channel 1014) and a second connection (e.g., via channel 1016). In some aspects, 1314 may be performed by the SN binding component 198.

In some aspects, the RLC header for the first subset of the second set of RLC SNs may include a first gap indicator indicating a first gap between a first current PDCP SN and a first previous PDCP SN for the first connection, and the RLC header for the second subset of the second set of RLC SNs may include a second gap indicator indicating the second gap between a second current PDCP SN and a second previous PDCP SN for the second connection. For example, referring to FIG. 10, the RLC header for the first subset of the second set of RLC SNs may include a first gap indicator (e.g., Δ_{PDCP_SN} 902) indicating a first gap between a first current PDCP SN and a first previous PDCP SN for the first connection (e.g., Δ_{PDCP_SN} 902=2 for PDCP SN 13 at 1006), and the RLC header for the second subset of the second set of RLC SNs may include a second gap indicator (e.g., Δ_{PDCP_SN} 902) indicating the second gap between a second current PDCP SN and a second previous PDCP SN for the second connection (e.g., Δ_{PDCP_SN} 902=3 for PDCP SN 15 at 1002).

In some aspects, to communicate the data packet with the network entity (at 1308), the UE may, at 1316, identify, based on the first gap indicator and the second gap indicator, a loss of transmissions associated with the first subset of the second set of RLC SNs and the second subset of the second set of RLC SN, respectively. For example, referring to FIG. 10, the UE may identify, based on the first gap indicator (e.g., Δ_{PDCP_SN} 902 in the RLC header associated with PDCP SN 11, 13, 14, 18 and 19) and the second gap indicator (e.g., Δ_{PDCP_SN} 902 in the RLC header associated with PDCP SN 15, 16, and 17), a loss of transmissions associated with the first subset of the second set of RLC SNs and the second subset of the second set of RLC SN, respectively. In some aspects, 1316 may be performed by the SN binding component 198.

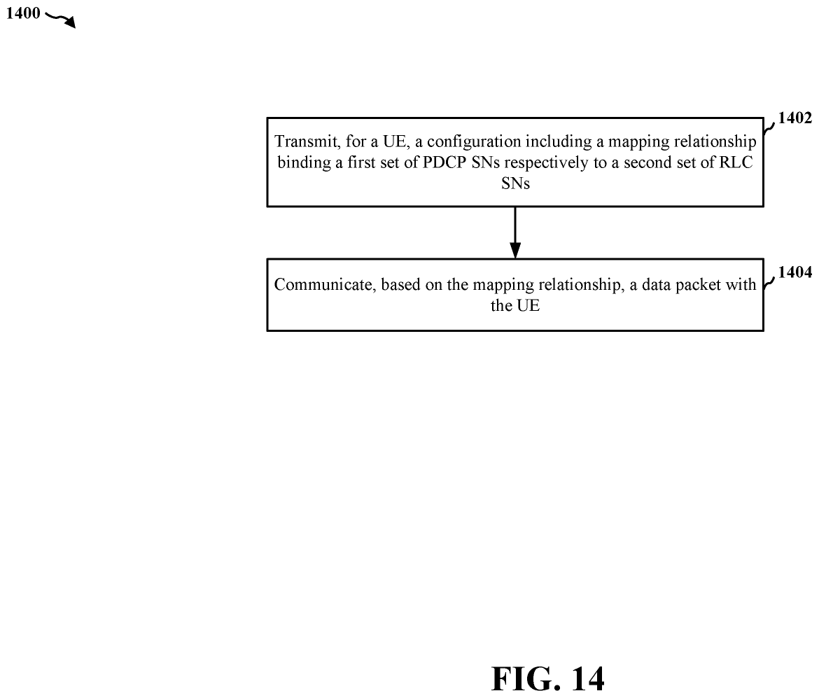

FIG. 14 is a flowchart 1400 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 1104; or the network entity 1602 in the hardware implementation of FIG. 16). Based on a binding relationship between PDCP SNs and RLC SNs, the methods enable the UE to map the PDCP reordering window to RLC SNs and vice versa to improve the handling of packet loss (e.g., packet loss on F1 interface) and reordering and reduce unnecessary RLC retransmission, thereby improving reliability and efficiency of wireless communication. Additionally, by allowing the tracking of losses and adjustments in the binding relationship, the methods ensure that data transmission remains efficient and reliable even in complex network configurations, such as dual connectivity.

As shown in FIG. 14, at 1402, the network entity may transmit, for a UE, a configuration including a mapping relationship binding a first set of PDCP SNs respectively to a second set of RLC SNs. The UE may be the UE 104, 350, 1102, or the apparatus 1604 in the hardware implementation of FIG. 16. FIG. 8, FIG. 10, FIG. 9, and FIG. 11 illustrate various aspects of the steps in connection with flowchart 1400. For example, referring to FIG. 11, the network entity (base station 1104) may transmit, at 1106, for a UE 1102, a configuration including a mapping relationship binding a first set of PDCP SNs respectively to a second set of RLC SNs. In some aspects, 1402 may be performed by the SN binding component 199.

At 1404, the network entity may communicate, based on the mapping relationship, a data packet with the UE. For example, referring to FIG. 11, the network entity (base station 1104) may communicate, at 1112, based on the mapping relationship, a data packet with the UE 1102. In some aspects, 1404 may be performed by the SN binding component 199.

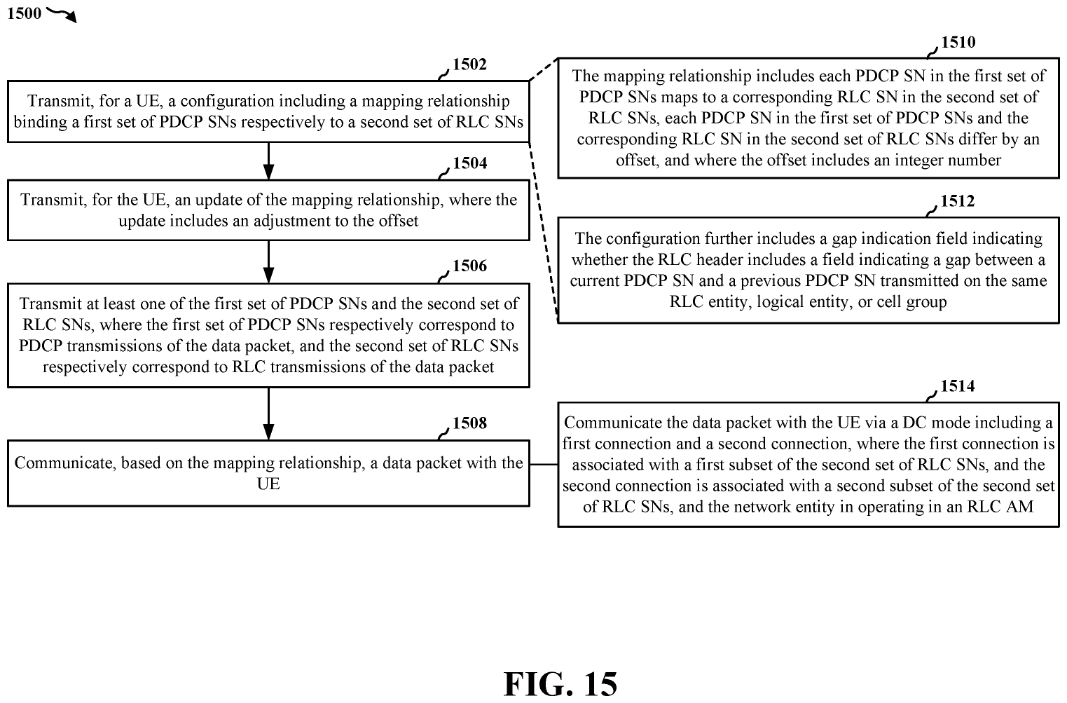

FIG. 15 is a flowchart 1500 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 1104; or the network entity 1602 in the hardware implementation of FIG. 16). Based on a binding relationship between PDCP SNs and RLC SNs, the methods enable the UE to map the PDCP reordering window to RLC SNs and vice versa to improve the handling of packet loss (e.g., packet loss on F1 interface) and reordering and reduce unnecessary RLC retransmission, thereby improving reliability and efficiency of wireless communication. Additionally, by allowing the tracking of losses and adjustments in the binding relationship, the methods ensure that data transmission remains efficient and reliable even in complex network configurations, such as dual connectivity.

As shown in FIG. 15, at 1502, the network entity may transmit, for a UE, a configuration including a mapping relationship binding a first set of PDCP SNs respectively to a second set of RLC SNs. The UE may be the UE 104, 350, 1102, or the apparatus 1604 in the hardware implementation of FIG. 16. FIG. 8, FIG. 10, FIG. 9, and FIG. 11 illustrate various aspects of the steps in connection with flowchart 1500. For example, referring to FIG. 11, the network entity (base station 1104) may transmit, at 1106, for a UE 1102, a configuration including a mapping relationship binding a first set of PDCP SNs respectively to a second set of RLC SNs. In some aspects, 1502 may be performed by the SN binding component 199.

At 1508, the network entity may communicate, based on the mapping relationship, a data packet with the UE. For example, referring to FIG. 11, the network entity (base station 1104) may communicate, at 1112, based on the mapping relationship, a data packet with the UE 1102. In some aspects, 1508 may be performed by the SN binding component 199.

In some aspects, at 1506, the network entity may transmit at least one of the first set of PDCP SNs and the second set of RLC SNs. The first set of PDCP SNs may respectively correspond to PDCP transmissions of the data packet, and the second set of RLC SNs may respectively correspond to RLC transmissions of the data packet. For example, referring to FIG. 11, the network entity (base station 1104) may transmit, at 1110, at least one of the first set of PDCP SNs and the second set of RLC SNs. The first set of PDCP SNs (e.g., PDCP SN 10, 11, 13, 14 in FIG. 5) may respectively correspond to PDCP transmissions of the data packet, and the second set of RLC SNs (e.g., RLC SN 10, 11, 12, 13 in FIG. 5) may respectively correspond to RLC transmissions of the data packet. In some aspects, 1506 may be performed by the SN binding component 199.

In some aspects, the data packet may be associated with an XR application. For example, referring to FIG. 11, the data packet (at 1112) may be associated with an XR application.

In some aspects, at 1510, the mapping relationship may include each PDCP SN in the first set of PDCP SNs maps to a corresponding RLC SN in the second set of RLC SNs. Each PDCP SN in the first set of PDCP SNs and the corresponding RLC SN in the second set of RLC SNs may differ by an offset. The offset may include an integer number. For example, referring to FIG. 11, the mapping relationship may be a one-on-one mapping (at 1130). Referring to FIG. 5, the mapping relationship may include the mapping of PDCP SN 10 to RLC SN 10 (at 530) or the mapping of PDCP SN 13 to RLC SN 12 (at 534), the offset between the PDCP SN and the corresponding RLC SN is zero (at 530) or 1 (at 534).

In some aspects, at 1504, the network entity may transmit, for the UE, an update of the mapping relationship. The update may include an adjustment to the offset. For example, referring to FIG. 11, the network entity (base station 1104) may transmit, at 1108, for the UE 1102, an update of the mapping relationship. Referring to FIG. 5, due to the data loss associated with PDCP SN 12, the base station may indicate to the UE to change the offset between the PDCP and RLC SNs from 0 (e.g., for mapping at 530 and 532) to 1 (for mapping at 534 and 536). In some aspects, 1504 may be performed by the SN binding component 199.

In some aspects, the network entity may transmit the update to the mapping relationship (at 1504) via one of: RRC signaling, MAC signaling, RLC control signaling, or PDCP control signaling. For example, referring to FIG. 11, the network entity (base station 1104) may transmit, at 1108, the update to the mapping relationship via one of: RRC signaling (at 1140), MAC signaling (at 1142), RLC control signaling (at 1144), or PDCP control signaling (at 1146).

In some aspects, the configuration including the mapping relationship may be included in a mapping field in an RLC header of a data PDU associated with the data packet. For example, referring to FIG. 8, the configuration including the mapping relationship may be included in a mapping field (e.g., SN Map field 810) in an RLC header of a data PDU associated with the data packet.

In some aspects, the mapping field may have a size of two bits and may indicate one or more of: the presence of the first set of PDCP SNs, the presence of the first set of PDCP SNs and an establishment of the mapping relationship between the first set of PDCP SNs and the second set of RLC SNs, or the usage of the mapping relationship between the first set of PDCP SNs and the second set of RLC SNs. For example, referring to FIG. 8 and Table 2, the mapping field (e.g., SN Map field 810) may have a size of two bits and may indicate the presence of the first set of PDCP SNs (e.g., when SN Map field 810 has the value of “00,” as shown in Table 2), the presence of the first set of PDCP SNs and an establishment of the mapping relationship between the first set of PDCP SNs and the second set of RLC SNs (e.g., when SN Map field 810 has the value of “01,” as shown in Table 2), or the usage or continuation of the mapping relationship between the first set of PDCP SNs and the second set of RLC SNs (e.g., when SN Map field 810 has the value of “10,” as shown in Table 2).

In some aspects, at 1512, the configuration may further include a gap indication field indicating whether the RLC header includes a field indicating a gap between a current PDCP SN and a previous PDCP SN transmitted on the same RLC entity, logical entity, or cell group. For example, referring to FIG. 9, the configuration may further include a gap indication field (e.g., 904) indicating whether the RLC header includes a field (e.g., Δ_{PDCP_SN} 902) indicating a gap between a current PDCP SN and a previous PDCP SN transmitted on the same RLC entity, logical entity, or cell group.

In some aspects, to communicate the data packet with the UE (at 1508), the network entity may, at 1514, communicate the data packet with the UE via a DC mode, including a first connection and a second connection. The first connection may be associated with a first subset of the second set of RLC SNs, and the second connection may be associated with a second subset of the second set of RLC SNs. The network entity may be operating in the RLC AM. For example, referring to FIG. 10, the network entity may communicate the data packet with the UE via a DC mode, including a first connection (e.g., via channel 1014) and a second connection (e.g., via channel 1016). In some aspects, 1514 may be performed by the SN binding component 199.

In some aspects, the RLC header for the first subset of the second set of RLC SNs may include a first gap indicator indicating a first gap between a first current PDCP SN and a first previous PDCP SN for the first connection. The RLC header for the second subset of the second set of RLC SNs may include a second gap indicator indicating the second gap between a second current PDCP SN and a second previous PDCP SN for the second connection. For example, referring to FIG. 10, the RLC header for the first subset of the second set of RLC SNs may include a first gap indicator (e.g., Δ_{PDCP_SN} 902) indicating a first gap between a first current PDCP SN and a first previous PDCP SN for the first connection (e.g., Δ_{PDCP_SN} 902=2 for PDCP SN 13 at 1006), and the RLC header for the second subset of the second set of RLC SNs may include a second gap indicator (e.g., Δ_{PDCP_SN} 902) indicating the second gap between a second current PDCP SN and a second previous PDCP SN for the second connection (e.g., Δ_{PDCP_SN} 902=3 for PDCP SN 15 at 1002).

FIG. 16 is a diagram 1600 illustrating an example of a hardware implementation for an apparatus 1604. The apparatus 1604 may be a UE, a component of a UE, or may implement UE functionality. In some aspects, the apparatus 1604 may include at least one cellular baseband processor (or processing circuitry) 1624 (also referred to as a modem) coupled to one or more transceivers 1622 (e.g., cellular RF transceiver). The cellular baseband processor(s) (or processing circuitry) 1624 may include at least one on-chip memory (or memory circuitry) 1624′. In some aspects, the apparatus 1604 may further include one or more subscriber identity modules (SIM) cards 1620 and at least one application processor (or processing circuitry) 1606 coupled to a secure digital (SD) card 1608 and a screen 1610. The application processor(s) (or processing circuitry) 1606 may include on-chip memory (or memory circuitry) 1606′. In some aspects, the apparatus 1604 may further include a Bluetooth module 1612, a WLAN module 1614, an SPS module 1616 (e.g., GNSS module), one or more sensor modules 1618 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1626, a power supply 1630, and/or a camera 1632. The Bluetooth module 1612, the WLAN module 1614, and the SPS module 1616 may include an on-chip transceiver (TRX) (or in some cases, just a receiver (RX)). The Bluetooth module 1612, the WLAN module 1614, and the SPS module 1616 may include their own dedicated antennas and/or utilize the antennas 1680 for communication. The cellular baseband processor(s) (or processing circuitry) 1624 communicates through the transceiver(s) 1622 via one or more antennas 1680 with the UE 104 and/or with an RU associated with a network entity 1602. The cellular baseband processor(s) (or processing circuitry) 1624 and the application processor(s) (or processing circuitry) 1606 may each include a computer-readable medium/memory (or memory circuitry) 1624′, 1606′, respectively. The additional memory modules 1626 may also be considered a computer-readable medium/memory (or memory circuitry). Each computer-readable medium/memory (or memory circuitry) 1624′, 1606′, 1626 may be non-transitory. The cellular baseband processor(s) (or processing circuitry) 1624 and the application processor(s) (or processing circuitry) 1606 are each responsible for general processing, including the execution of software stored on the computer-readable medium/memory (or memory circuitry). The software, when executed by the cellular baseband processor(s) (or processing circuitry) 1624/application processor(s) (or processing circuitry) 1606, causes the cellular baseband processor(s) (or processing circuitry) 1624/application processor(s) (or processing circuitry) 1606 to perform the various functions described supra. The cellular baseband processor(s) (or processing circuitry) 1624 and the application processor(s) (or processing circuitry) 1606 are configured to perform the various functions described supra based at least in part of the information stored in the memory (or memory circuitry). That is, the cellular baseband processor(s) (or processing circuitry) 1624 and the application processor(s) (or processing circuitry) 1606 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1624/application processor(s) (or processing circuitry) 1606 when executing software. The cellular baseband processor(s) (or processing circuitry) 1624/application processor(s) (or processing circuitry) 1606 may be a component of the UE 350 and may include the at least one memory 360 and/or at least one of the TX processor 368, the RX processor 356, and the controller/processor 359. In one configuration, the apparatus 1604 may be at least one processor chip (modem and/or application) and include just the cellular baseband processor(s) (or processing circuitry) 1624 and/or the application processor(s) (or processing circuitry) 1606, and in another configuration, the apparatus 1604 may be the entire UE (e.g., see UE 350 of FIG. 3) and include the additional modules of the apparatus 1604.

As discussed supra, the component 198 may be configured to receive, from a network entity, a configuration including a mapping relationship binding a first set of PDCP SNs respectively to a second set of RLC SNs; and communicate, based on the mapping relationship, a data packet with the network entity. The component 198 may be further configured to perform any of the aspects described in connection with the flowcharts in FIG. 12 and FIG. 13, and/or performed by the UE 1102 in FIG. 11. The component 198 may be within the cellular baseband processor(s) (or processing circuitry) 1624, the application processor(s) (or processing circuitry) 1606, or both the cellular baseband processor(s) (or processing circuitry) 1624 and the application processor(s) (or processing circuitry) 1606. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1604 may include a variety of components configured for various functions. In one configuration, the apparatus 1604, and in particular the cellular baseband processor(s) (or processing circuitry) 1624 and/or the application processor(s) (or processing circuitry) 1606, includes means for receiving, from a network entity, a configuration including a mapping relationship binding a first set of PDCP SNs respectively to a second set of RLC SNs, and means for communicating, based on the mapping relationship, a data packet with the network entity. The apparatus 1604 may further include means for performing any of the aspects described in connection with the flowcharts in FIG. 12 and FIG. 13, and/or aspects performed by the UE 1102 in FIG. 11. The means may be the component 198 of the apparatus 1604 configured to perform the functions recited by the means. As described supra, the apparatus 1604 may include the TX processor 368, the RX processor 356, and the controller/processor 359. As such, in one configuration, the means may be the TX processor 368, the RX processor 356, and/or the controller/processor 359 configured to perform the functions recited by the means.

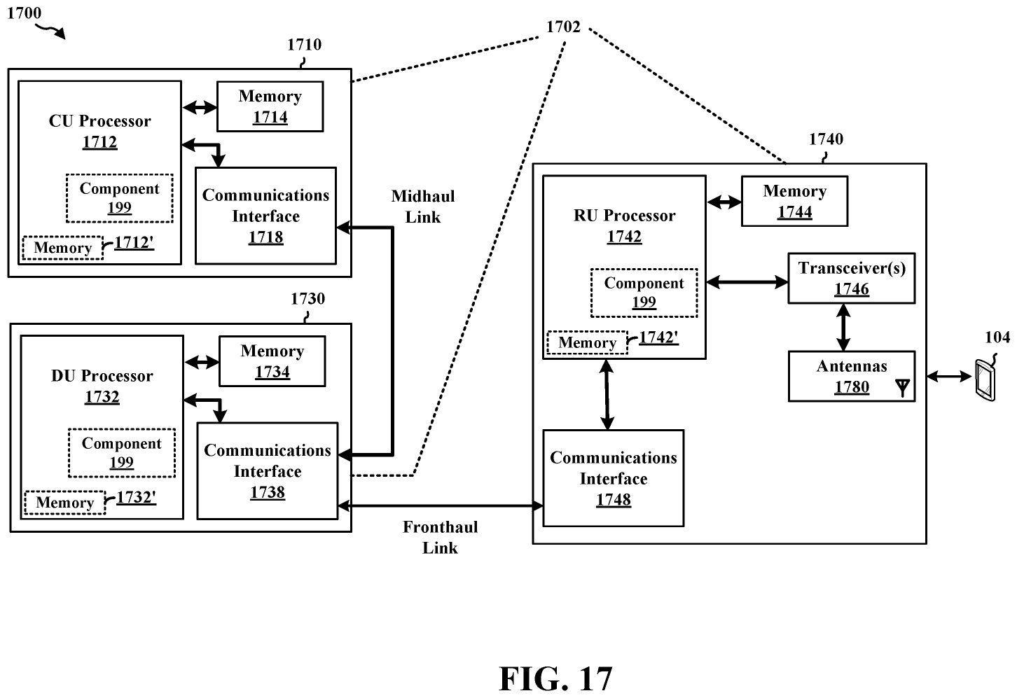

FIG. 17 is a diagram 1700 illustrating an example of a hardware implementation for a network entity 1702. The network entity 1702 may be a BS, a component of a BS, or may implement BS functionality. The network entity 1702 may include at least one of a CU 1710, a DU 1730, or an RU 1740. For example, depending on the layer functionality handled by the component 199, the network entity 1702 may include the CU 1710; both the CU 1710 and the DU 1730; each of the CU 1710, the DU 1730, and the RU 1740; the DU 1730; both the DU 1730 and the RU 1740; or the RU 1740. The CU 1710 may include at least one CU processor (or processing circuitry) 1712. The CU processor(s) (or processing circuitry) 1712 may include on-chip memory (or memory circuitry) 1712′. In some aspects, the CU 1710 may further include additional memory modules 1714 and a communications interface 1718. The CU 1710 communicates with the DU 1730 through a midhaul link, such as an F1 interface. The DU 1730 may include at least one DU processor (or processing circuitry) 1732. The DU processor(s) (or processing circuitry) 1732 may include on-chip memory (or memory circuitry) 1732′. In some aspects, the DU 1730 may further include additional memory modules 1734 and a communications interface 1738. The DU 1730 communicates with the RU 1740 through a fronthaul link. The RU 1740 may include at least one RU processor (or processing circuitry) 1742. The RU processor(s) (or processing circuitry) 1742 may include on-chip memory (or memory circuitry) 1742′. In some aspects, the RU 1740 may further include additional memory modules 1744, one or more transceivers 1746, antennas 1780, and a communications interface 1748. The RU 1740 communicates with the UE 104. The on-chip memory (or memory circuitry) 1712′, 1732′, 1742′ and the additional memory modules 1714, 1734, 1744 may each be considered a computer-readable medium/memory (or memory circuitry). Each computer-readable medium/memory (or memory circuitry) may be non-transitory. Each of the processors (or processing circuitry) 1712, 1732, 1742 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to transmit, for a UE, a configuration including a mapping relationship binding a first set of PDCP SNs respectively to a second set of RLC SNs; and communicate, based on the mapping relationship, a data packet with the UE. The component 199 may be further configured to perform any of the aspects described in connection with the flowcharts in FIG. 14 and FIG. 15, and/or performed by the base station 1104 in FIG. 11. The component 199 may be within one or more processors (or processing circuitry) of one or more of the CU 1710, DU 1730, and the RU 1740. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1702 may include a variety of components configured for various functions. In one configuration, the network entity 1702 includes means for transmitting, for a UE, a configuration including a mapping relationship binding a first set of PDCP SNs respectively to a second set of RLC SNs, and means for communicating, based on the mapping relationship, a data packet with the UE. The network entity 1702 may further include means for performing any of the aspects described in connection with the flowcharts in FIG. 14 and FIG. 15, and/or aspects performed by the base station 1104 in FIG. 11. The means may be the component 199 of the network entity 1702 configured to perform the functions recited by the means. As described supra, the network entity 1702 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include receiving, from a network entity, a configuration including a mapping relationship binding a first set of PDCP SNs respectively to a second set of RLC SNs; and communicating, based on the mapping relationship, a data packet with the network entity. Based on a binding relationship between PDCP SNs and RLC SNs, the methods enable the UE to map the PDCP reordering window to RLC SNs and vice versa to improve the handling of packet loss (e.g., packet loss on F1 interface) and reordering and reduce unnecessary RLC retransmission, thereby improving reliability and efficiency of wireless communication. Additionally, by allowing the tracking of losses and adjustments in the binding relationship, the methods ensure that data transmission remains efficient and reliable even in complex network configurations, such as dual connectivity.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a UE. The method includes receiving, from a network entity, a configuration comprising a mapping relationship binding a first set of packet data convergence protocol (PDCP) sequence numbers (SNs) respectively to a second set of radio link control (RLC) SNs; and communicating, based on the mapping relationship, a data packet with the network entity.
Aspect 2 is the method of aspect 1, where the method further includes receiving at least one of the first set of PDCP SNs and the second set of RLC SNs, wherein the first set of PDCP SNs respectively correspond to PDCP transmissions of the data packet, and the second set of RLC SNs respectively correspond to RLC transmissions of the data packet.
Aspect 3 is the method of any of aspects 1 to 2, wherein the data packet is associated with an extended reality (XR) application.
Aspect 4 is the method of any of aspects 1 to 3, wherein the mapping relationship includes each PDCP SN in the first set of PDCP SNs maps to a corresponding RLC SN in the second set of RLC SNs, each PDCP SN in the first set of PDCP SNs and the corresponding RLC SN in the second set of RLC SNs differ by an offset, and wherein the offset includes an integer number.
Aspect 5 is the method of aspect 4, wherein communicating the data packet with the network entity comprises: identifying, based on the mapping relationship and one of the first set of PDCP SNs and the second set of RLC SNs, a transmission status associated with an other one of the first set of PDCP SNs and the second set of RLC SN; and communicating, based on the transmission status, the data packet with the network entity.
Aspect 6 is the method of aspect 4, where the method further includes identifying, based on the mapping relationship and the second set of RLC SNs, a PDCP reordering window for the PDCP transmissions of the data packet.
Aspect 7 is the method of aspect 6, wherein identifying the PDCP reordering window comprises: identifying, in response to a received PDCP SN mapping to a mapped RLC SN greater than a next received RLC SN, an advancement of the PDCP reordering window. The method further includes moving, in response to the advancement of the PDCP reordering window, the next received RLC SN to a first RLC SN in the second set of RLC SNs equal to or greater than the mapped RLC SN, wherein the first RLC SN corresponds to the RLC transmissions that have not been received.
Aspect 8 is the method of aspect 7, where the method further includes transmitting, for the network entity, an acknowledgement of the advancement of the PDCP reordering window.
Aspect 9 is the method of aspect 7, where the method further includes updating, in response to the advancement of the PDCP reordering window, a reassembly timer associated with the transmissions of the data packet.
Aspect 10 is the method of any of aspects 1 to 4, where the method further includes receiving, from the network entity, an update of the mapping relationship, wherein the update includes an adjustment to the offset.
Aspect 11 is the method of aspect 10, wherein receiving the update to the mapping relationship comprises: receiving the update to the mapping relationship via one of: radio resource control (RRC) signaling, medium access control (MAC) signaling, RLC control signaling, or PDCP control signaling.
Aspect 12 is the method of any of aspects 1 to 2, wherein the configuration comprising the mapping relationship is included in a mapping field in an RLC header of a data protocol data unit (PDU) associated with the data packet.
Aspect 13 is the method of aspect 12, wherein the mapping field has a size of two bits and indicates one or more of: a presence of the first set of PDCP SNs, the presence of the first set of PDCP SNs and an establishment of the mapping relationship between the first set of PDCP SNs and the second set of RLC SNs, or a usage of the mapping relationship between the first set of PDCP SNs and the second set of RLC SNs.
Aspect 14 is the method of aspect 12, wherein the configuration further includes a gap indication field indicating whether the RLC header includes a field indicating a gap between a current PDCP SN and a previous PDCP SN transmitted on the same RLC entity, logical entity, or cell group.
Aspect 15 is the method of aspect 14, wherein communicating the data packet with the network entity comprises: communicating the data packet with the network entity via a dual connectivity (DC) mode comprising a first connection and a second connection, wherein the first connection is associated with a first subset of the second set of RLC SNs, and the second connection is associated with a second subset of the second set of RLC SNs, and the network entity in operating in an RLC acknowledge mode (AM).
Aspect 16 is the method of aspect 15, wherein the RLC header for the first subset of the second set of RLC SNs includes a first gap indicator indicating a first gap between a first current PDCP SN and a first previous PDCP SN for the first connection, and the RLC header for the second subset of the second set of RLC SNs includes a second gap indicator indicating the second gap between a second current PDCP SN and a second previous PDCP SN for the second connection.
Aspect 17 is the method of aspect 16, where the method further includes identifying, based on the first gap indicator and the second gap indicator, a loss of transmissions associated with the first subset of the second set of RLC SNs and the second subset of the second set of RLC SN, respectively.
Aspect 18 is an apparatus for wireless communication at a UE, comprising: a processing system that includes processor circuitry and memory circuitry that stores code and is coupled with the processor circuitry, the processing system configured to cause the UE to perform the method of one or more of aspects 1-17.
Aspect 19 is an apparatus for wireless communication at a UE, comprising: at least one memory; and at least one processor coupled to the at least one memory and, where the at least one processor, individually or in any combination, is configured to perform the method of any of aspects 1-17.
Aspect 20 is the apparatus for wireless communication at a UE, comprising means for performing each step in the method of any of aspects 1-17.
Aspect 21 is an apparatus of any of aspects 18-20, further comprising a transceiver configured to receive or to transmit in association with the method of any of aspects 1-17.
Aspect 22 is a computer-readable medium (e.g., a non-transitory computer-readable medium) storing computer executable code at a UE, the code when executed by at least one processor causes the at least one processor to, individually or in any combination, perform the method of any of aspects 1-17.
Aspect 23 is a method of wireless communication at a network entity. The method includes transmitting, for a user equipment (UE), a configuration comprising a mapping relationship binding a first set of packet data convergence protocol (PDCP) sequence numbers (SNs) respectively to a second set of radio link control (RLC) SNs; and communicating, based on the mapping relationship, a data packet with the UE.
Aspect 24 is the method of aspect 23, where the method further includes transmitting at least one of the first set of PDCP SNs and the second set of RLC SNs, wherein the first set of PDCP SNs respectively correspond to PDCP transmissions of the data packet, and the second set of RLC SNs respectively correspond to RLC transmissions of the data packet.
Aspect 25 is the method of any of aspects 23 to 24, wherein the data packet is associated with an extended reality (XR) application.
Aspect 26 is the method of any of aspects 23 to 25, wherein the mapping relationship includes each PDCP SN in the first set of PDCP SNs maps to a corresponding RLC SN in the second set of RLC SNs, each PDCP SN in the first set of PDCP SNs and the corresponding RLC SN in the second set of RLC SNs differ by an offset, and wherein the offset includes an integer number.
Aspect 27 is the method of any of aspects 23 to 26, where the method further includes transmitting, for the UE, an update of the mapping relationship, wherein the update includes an adjustment to the offset.
Aspect 28 is the method of aspect 27, wherein transmitting the update to the mapping relationship comprises: transmitting the update to the mapping relationship via one of: radio resource control (RRC) signaling, medium access control (MAC) signaling, RLC control signaling or PDCP control signaling.
Aspect 29 is the method of any of aspects 23 to 24, wherein the configuration comprising the mapping relationship is included in a mapping field in an RLC header of a data protocol data unit (PDU) associated with the data packet.
Aspect 30 is the method of aspect 29, wherein the mapping field has a size of two bits and indicates one or more of: a presence of the first set of PDCP SNs, the presence of the first set of PDCP SNs and an establishment of the mapping relationship between the first set of PDCP SNs and the second set of RLC SNs, or a usage of the mapping relationship between the first set of PDCP SNs and the second set of RLC SNs.
Aspect 31 is the method of any of aspects 23 to 29, wherein the configuration further includes a gap indication field indicating whether the RLC header includes a field indicating a gap between a current PDCP SN and a previous PDCP SN transmitted on the same RLC entity, logical entity, or cell group.
Aspect 32 is the method of aspect 31, wherein communicating the data packet with the UE comprises: communicating the data packet with the UE via a dual connectivity (DC) mode comprising a first connection and a second connection, wherein the first connection is associated with a first subset of the second set of RLC SNs, and the second connection is associated with a second subset of the second set of RLC SNs, and the network entity in operating in an RLC acknowledge mode (AM).
Aspect 33 is the method of aspect 32, wherein the RLC header for the first subset of the second set of RLC SNs includes a first gap indicator indicating a first gap between a first current PDCP SN and a first previous PDCP SN for the first connection, and the RLC header for the second subset of the second set of RLC SNs includes a second gap indicator indicating the second gap between a second current PDCP SN and a second previous PDCP SN for the second connection.
Aspect 34 is an apparatus for wireless communication at a network entity, comprising: a processing system that includes processor circuitry and memory circuitry that stores code and is coupled with the processor circuitry, the processing system configured to cause the network entity to perform the method of one or more of aspects 23-33.
Aspect 35 is an apparatus for wireless communication at a network entity, comprising: at least one memory; and at least one processor coupled to the at least one memory and, where the at least one processor, individually or in any combination, is configured to perform the method of any of aspects 23-33.
Aspect 36 is the apparatus for wireless communication at a network entity, comprising means for performing each step in the method of any of aspects 23-33.
Aspect 37 is an apparatus of any of aspects 34-36, further comprising a transceiver configured to receive or to transmit in association with the method of any of aspects 23-33.
Aspect 38 is a computer-readable medium (e.g., a non-transitory computer-readable medium) storing computer executable code at a network entity, the code when executed by at least one processor causes the at least one processor to, individually or in any combination, perform the method of any of aspects 23-33.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to cause the UE to:
receive, from a network entity, a configuration comprising a mapping relationship binding a first set of packet data convergence protocol (PDCP) sequence numbers (SNs) respectively to a second set of radio link control (RLC) SNs; and
communicate, based on the mapping relationship, a data packet with the network entity.

2. The apparatus of claim 1, further comprising a transceiver coupled to the at least one processor, wherein to receive the configuration, the at least one processor, individually or in any combination, is configured to cause the UE to receive the configuration via the transceiver, and wherein the at least one processor, individually or in any combination, is further configured to cause the UE to:
receive at least one of the first set of PDCP SNs and the second set of RLC SNs, wherein the first set of PDCP SNs respectively correspond to PDCP transmissions of the data packet, and the second set of RLC SNs respectively correspond to RLC transmissions of the data packet.

3. The apparatus of claim 2, wherein the data packet is associated with an extended reality (XR) application.

4. The apparatus of claim 2, wherein the mapping relationship includes each PDCP SN in the first set of PDCP SNs maps to a corresponding RLC SN in the second set of RLC SNs, and each PDCP SN in the first set of PDCP SNs and the corresponding RLC SN in the second set of RLC SNs differ by an offset, and wherein the offset includes an integer number.

5. The apparatus of claim 4, wherein to communicate the data packet with the network entity, the at least one processor, individually or in any combination, is configured to cause the UE to:
identify, based on the mapping relationship and one of the first set of PDCP SNs and the second set of RLC SNs, a transmission status associated with an other one of the first set of PDCP SNs and the second set of RLC SN; and
communicate, based on the transmission status, the data packet with the network entity.

6. The apparatus of claim 4, wherein the at least one processor, individually or in any combination, is further configured to cause the UE to:
identify, based on the mapping relationship and the second set of RLC SNs, a PDCP reordering window for the PDCP transmissions of the data packet.

7. The apparatus of claim 6, wherein to identify the PDCP reordering window, the at least one processor, individually or in any combination, is configured to cause the UE to:
identify, in response to a received PDCP SN mapping to a mapped RLC SN greater than a next received RLC SN, an advancement of the PDCP reordering window; and wherein the at least one processor, individually or in any combination, is further configured to cause the UE to:
move, in response to the advancement of the PDCP reordering window, the next received RLC SN to a first RLC SN in the second set of RLC SNs equal to or greater than the mapped RLC SN, wherein the first RLC SN corresponds to the RLC transmissions that have not been received.

8. The apparatus of claim 7, wherein the at least one processor, individually or in any combination, is further configured to cause the UE to:
transmit, for the network entity, an acknowledgement of the advancement of the PDCP reordering window.

9. The apparatus of claim 7, wherein the at least one processor, individually or in any combination, is further configured to cause the UE to:
update, in response to the advancement of the PDCP reordering window, a reassembly timer associated with the transmissions of the data packet.

10. The apparatus of claim 4, wherein the at least one processor, individually or in any combination, is further configured to cause the UE to:
receive, from the network entity, an update of the mapping relationship, wherein the update includes an adjustment to the offset.

11. The apparatus of claim 10, wherein to receive the update to the mapping relationship, the at least one processor, individually or in any combination, is configured to cause the UE to:
receive the update to the mapping relationship via one of:
radio resource control (RRC) signaling,
medium access control (MAC) signaling,
RLC control signaling, or
PDCP control signaling.

12. The apparatus of claim 2, wherein the configuration comprising the mapping relationship is included in a mapping field in an RLC header of a data protocol data unit (PDU) associated with the data packet.

13. The apparatus of claim 12, wherein the mapping field has a size of two bits and indicates one or more of:
a presence of the first set of PDCP SNs,
the presence of the first set of PDCP SNs and an establishment of the mapping relationship between the first set of PDCP SNs and the second set of RLC SNs, or
a usage or a continuation of the mapping relationship between the first set of PDCP SNs and the second set of RLC SNs.

14. The apparatus of claim 12, wherein the configuration further includes a gap indication field indicating whether the RLC header includes a field indicating a gap between a current PDCP SN and a previous PDCP SN transmitted on a same RLC entity, logical entity, or cell group.

15. The apparatus of claim 14, wherein to communicate the data packet with the network entity, the at least one processor, individually or in any combination, is configured to cause the UE to:
communicate the data packet with the network entity via a dual connectivity (DC) mode comprising a first connection and a second connection, wherein the first connection is associated with a first subset of the second set of RLC SNs, and the second connection is associated with a second subset of the second set of RLC SNs, and the network entity in operating in an RLC acknowledge mode (AM).

16. The apparatus of claim 15, wherein the RLC header for the first subset of the second set of RLC SNs includes a first gap indicator indicating a first gap between a first current PDCP SN and a first previous PDCP SN for the first connection, and the RLC header for the second subset of the second set of RLC SNs includes a second gap indicator indicating the second gap between a second current PDCP SN and a second previous PDCP SN for the second connection.

17. The apparatus of claim 16, wherein to communicate the data packet with the network entity, the at least one processor, individually or in any combination, is configured to cause the UE to:
identify, based on the first gap indicator and the second gap indicator, a loss of transmissions associated with the first subset of the second set of RLC SNs and the second subset of the second set of RLC SN, respectively.

18. An apparatus for wireless communication at a network entity, comprising:
at least one memory; and
at least one processor coupled to the at least one memory and, based at least in part on information stored in the at least one memory, the at least one processor, individually or in any combination, is configured to cause the network entity to:
transmit, for a user equipment (UE), a configuration comprising a mapping relationship binding a first set of packet data convergence protocol (PDCP) sequence numbers (SNs) respectively to a second set of radio link control (RLC) SNs; and
communicate, based on the mapping relationship, a data packet with the UE.

19. The apparatus of claim 18, further comprising a transceiver coupled to the at least one processor, wherein to transmit the configuration, the at least one processor, individually or in any combination, is configured to transmit the configuration via the transceiver, and wherein the at least one processor, individually or in any combination, is further configured to cause the network entity to:
transmit at least one of the first set of PDCP SNs and the second set of RLC SNs, wherein the first set of PDCP SNs respectively correspond to PDCP transmissions of the data packet, and the second set of RLC SNs respectively correspond to RLC transmissions of the data packet.

20. The apparatus of claim 19, wherein the data packet is associated with an extended reality (XR) application.

21. The apparatus of claim 19, wherein the mapping relationship includes each PDCP SN in the first set of PDCP SNs maps to a corresponding RLC SN in the second set of RLC SNs, each PDCP SN in the first set of PDCP SNs and the corresponding RLC SN in the second set of RLC SNs differ by an offset, and wherein the offset includes an integer number.

22. The apparatus of claim 21, wherein the at least one processor, individually or in any combination, is further configured to cause the network entity to:
transmit, for the UE, an update of the mapping relationship, wherein the update includes an adjustment to the offset.

23. The apparatus of claim 22, wherein to transmit the update to the mapping relationship, the at least one processor, individually or in any combination, is configured to cause the network entity to:
transmit the update to the mapping relationship via one of:
radio resource control (RRC) signaling,
medium access control (MAC) signaling,
RLC control signaling, or
PDCP control signaling.

24. The apparatus of claim 19, wherein the configuration comprising the mapping relationship is included in a mapping field in an RLC header of a data protocol data unit (PDU) associated with the data packet.

25. The apparatus of claim 24, wherein the mapping field has a size of two bits and indicates one or more of:
a presence of the first set of PDCP SNs,
the presence of the first set of PDCP SNs and an establishment of the mapping relationship between the first set of PDCP SNs and the second set of RLC SNs, or
a usage of the mapping relationship between the first set of PDCP SNs and the second set of RLC SNs.

26. The apparatus of claim 24, wherein the configuration further includes a gap indication field indicating whether the RLC header includes a field indicating a gap between a current PDCP SN and a previous PDCP SN transmitted on a same RLC entity, logical entity, or cell group.

27. The apparatus of claim 26, wherein to communicate the data packet with the UE, the at least one processor, individually or in any combination, is further configured to cause the network entity to:
communicate the data packet with the UE via a dual connectivity (DC) mode comprising a first connection and a second connection, wherein the first connection is associated with a first subset of the second set of RLC SNs, and the second connection is associated with a second subset of the second set of RLC SNs, and the network entity in operating in an RLC acknowledge mode (AM).

28. The apparatus of claim 27, wherein the RLC header for the first subset of the second set of RLC SNs includes a first gap indicator indicating a first gap between a first current PDCP SN and a first previous PDCP SN for the first connection, and the RLC header for the second subset of the second set of RLC SNs includes a second gap indicator indicating the second gap between a second current PDCP SN and a second previous PDCP SN for the second connection.

29. A method of wireless communication at a user equipment (UE), comprising:
receiving, from a network entity, a configuration comprising a mapping relationship binding a first set of packet data convergence protocol (PDCP) sequence numbers (SNs) respectively to a second set of radio link control (RLC) SNs; and
communicating, based on the mapping relationship, a data packet with the network entity.

30. A method of wireless communication at a network entity, comprising:
transmitting, for a user equipment (UE), a configuration comprising a mapping relationship binding a first set of packet data convergence protocol (PDCP) sequence numbers (SNs) respectively to a second set of radio link control (RLC) SNs; and
communicating, based on the mapping relationship, a data packet with the UE.
